(19) United States
(12) Patent Application Publication
(10) Pub. No.: US 2017/0270567 A1
(43) Pub. Date: Sep. 21, 2017

(54) ADVERTISING PLATFORM DEVICE

(71) Applicant: SK Planet Co., Ltd., Seongnam-si (KR)

(72) Inventor: Sang Mok SOHN, Seongnam-si (KR)

(21) Appl. No.: 15/389,746

(22) Filed: Dec. 23, 2016

(30) Foreign Application Priority Data
Mar. 18, 2016 (KR) 10-2016-0032971
Mar. 23, 2016 (KR) 10-2016-0034581
Jun. 15, 2016 (KR) 10-2016-0074582

(51) Int. Cl. G06Q 30/02

(52) U.S. Cl. CPC G06Q 30/0269

(57) ABSTRACT

Disclosed is an advertising platform device for determining a priority by using a preference of a user within a new receiver group selected to receive a new advertisement with respect to an existing advertisement having a high similarity with the new advertisement and providing the new advertisement according to the determined priority.

### CROSS-REFERENCE TO RELATED APPLICATIONS

The instant application is based on and claims priority to Korean Patent Application No. 10-2016-0032971, filed on Mar. 18, 2016, Korean Patent Application No. 10-2016-0034581, filed on Mar. 23, 2016, Korean Patent Application No. 10-2016-0074582, filed on Jun. 15, 2016. The disclosures of above-listed applications are hereby incorporated by reference herein in their entirety.

### TECHNICAL FIELD

The present disclosure relates to a scheme of determining priorities related to provision of a new advertisement to users within a selected new receiver group to receive the new advertisement.

Further, the present disclosure relates to a scheme of providing an advertisement to a user who does not agree with the use of personal information through the use of log information of an accessor of a service device.

In addition, the present disclosure relates to a scheme of detecting whether abuse is generated in an advertisement medium through a browser call pattern related to a browser called by a terminal that selects an advertisement within the advertisement medium.

### BACKGROUND ART

As the market of applications that are advertisement media executed by mobile devices such as smart phones, tablet computers, and the like rapidly expands, advertisement market related thereto is expanding at a high speed.

In connection with this, when executing the application or accessing a service page (for example, a webpage) which are the advertisement medium, the mobile device (hereinafter, referral to as a “terminal device”) receives an advertisement provided from an advertising platform device and displays the received advertisement.

At this time, the advertising platform device may expect an advertisement effect by securing a receiver group (hereinafter, referral to as a “new receiver group”) suitable for receiving a registered new advertisement from an advertiser and providing the new advertisement to the secured new receiver group.

However, due to the lack of advertisement budget, the new advertisement may not be provided to all users within the new receiver group. In this case, the new advertisement may be provided only to some users within the new receiver group and thus a sufficient advertisement effect cannot be expected.

Meanwhile, the advertising platform device constructs its own targeting logic and selects an advertisement suitable for the current situation of a user having an advertisement medium device through the targeting logic, thereby providing the selected advertisement to the advertisement medium device as a targeting advertisement.

However, such a targeting advertisement scheme is generally performed only for users who agree with the use of personal information. For example, the targeting advertisement scheme is performed based on user identification information (ID) that is subscribed as a member.

Accordingly, there is a limitation in that the targeting advertisement cannot be provided to users who are not members or users who do not agree with the use of other personal information.

Advertisement history information related to reception and selection of an advertisement and access to an advertiser page performed through the advertisement medium may be collected as statistical information, and the statistical information may be used for measuring an advertisement effect and settling up advertisement expense.

However, the advertisement history information collected as the statistical information may be fabricated through various types of abuse. When the advertisement history information is fabricated, the generation of errors in measuring the advertisement effect and settling up the advertisement expense may be expected.

### SUMMARY

The present disclosure has been made to solve the above problems, and an objective to be achieved by the present disclosure is to determine priorities related to the provision of a new advertisement to users within a new receiver group selected to receive the new advertisement and provide the new advertisement according to the determined priorities.

Further, the present disclosure has been made to solve the above problems, and another objective to be achieved by the present disclosure is to provide a targeted advertisement even to users who do not agree with the use of personal information by classifying an accessor group having a particular log information pattern identified in a service device and providing an advertisement related to an item preferred by the classified accessor group to an accessor group having the same log information pattern identified in another service device.

In addition, another objective to be achieved by the present disclosure is to detect whether abuse is generated in an advertisement medium based on a browser call pattern related to a browser called by a terminal having selected an advertisement within the advertisement medium.

An advertising platform device according to an embodiment of the present disclosure to achieve the objective includes: a processor configured to perform an operation related to a new advertisement; and a memory configured to store at least one instruction executed through the processor, wherein the at least one instruction includes: an identification instruction for identifying a new receiver group selected in connection with the new advertisement and an existing receiver group which has been pre-selected in connection with an existing advertisement having a similarity with the new advertisement larger than or equal to a threshold value; a classification instruction for classifying overlapping users between the new receiver group and the existing receiver group as an overlapping receiver group; and a determination instruction for determining priorities of users within the overlapping receiver group based on a preference of the users within the overlapping receiver group with respect to the existing advertisement and providing the new advertisement to each of the users within the overlapping receiver group according to the priorities.

An advertising platform device according to an embodiment of the present disclosure to achieve the objective includes: a processor configured to perform an operation related to an advertisement; and a memory configured to store at least one instruction executed through the processor, wherein the at least one instruction includes: a classification instruction for classifying a first accessor group having a particular log information pattern is identified in a first service device and a second accessor group having the particular log information pattern identically identified in a second service device having a correlation with the first service device higher than or equal to a threshold value; and a generation instruction for generating a first item list having a preference higher than or equal to a threshold value within the first access group among items related to the first service device and providing advertisements related to the first item list to the second accessor group.

An advertising platform device according to an embodiment of the present disclosure to achieve the objective includes: a processor configured to perform an operation related to detecting whether abuse is generated in an advertisement medium; and a memory configured to store at least one instruction executed through the processor, wherein the at least one instruction includes: a setting instruction for setting browser policy information that defines a browser which should be called by a terminal having selected an advertisement within the advertisement medium in connection with the advertisement medium; a collection instruction for collecting browser call history information related to a browser which is called by the terminal having selected an advertisement within the advertisement medium; and a detection instruction for detecting the generation of the abuse in the advertisement medium when it is determined that a similarity between a first browser call pattern defined in the browser policy information and a second browser call pattern identified from the browser call history information is smaller than a threshold value.

According to the advertising platform device of the present disclosure, it is possible to acquire an effect of improving an advertisement effect by determining priorities based on preference of users within a new receiver group selected to receive a new advertisement with respect to the existing advertisement having a higher similarity with the new advertisement and providing the new advertisement according to the determined priorities.

Further, according to the advertising platform device of the present disclosure, it is possible to provide a targeted advertisement even to a user who does not agree with the use of personal information by classifying an accessor group of which a particular log information pattern is identified in a service device and providing an advertisement related to an item preferred by the classified accessor group to an accessor group of which the same log information pattern is identified in another service device.

In addition, according to the advertising platform device of the present disclosure, it is possible to effectively detect whether abuse is generated in an advertisement medium by determining a similarity between an actual browser call pattern in a terminal that selects an advertisement within the advertisement medium and a browser call pattern defined in browser policy information.

### BRIEF DESCRIPTION OF THE DRAWINGS

The above and other objects, features and advantages of the present disclosure will be more apparent from the following detailed description taken in conjunction with the accompanying drawings, in which:

FIG. 1 schematically illustrates a configuration of an advertisement providing system according to a first embodiment of the present disclosure;

FIG. 2 schematically illustrates a configuration of a terminal device according to the first embodiment of the present disclosure;

FIG. 3 schematically illustrates a configuration of an advertising platform device according to the first embodiment of the present disclosure;

FIG. 4 schematically illustrates a configuration of a hardware system for implementing the advertising platform device according to the first embodiment of the present disclosure;

FIG. 5 is a flowchart illustrating a flow of operations of the advertising platform device according to the first embodiment of the present disclosure;

FIG. 6 schematically illustrates a configuration of an advertisement providing system according to a second embodiment of the present disclosure;

FIG. 7 schematically illustrates a configuration of a terminal device according to a second embodiment of the present disclosure;

FIG. 8 schematically illustrates a configuration of an advertising platform device according to the second embodiment of the present disclosure;

FIG. 9 illustrates an example of classification items according to the second embodiment of the present disclosure;

FIG. 10 schematically illustrates a configuration of a hardware system for implementing the advertising platform device according to the second embodiment of the present disclosure;

FIG. 11 is a flowchart illustrating a flow of operations of the advertising platform device according to the second embodiment of the present disclosure;

FIG. 12 schematically illustrates a configuration of an advertisement providing system according to a third embodiment of the present disclosure;

FIG. 13 schematically illustrates a configuration of a terminal according to the third embodiment of the present disclosure;

FIG. 14 schematically illustrates a configuration of an advertising platform device according to the third embodiment of the present disclosure;

FIG. 15 schematically illustrates a configuration of a hardware system for implementing the advertising platform device according to the third embodiment of the present disclosure; and

FIG. 16 is a flowchart illustrating a flow of operations of the advertising platform device according to the third embodiment of the present disclosure.

### DETAILED DESCRIPTION OF THE EXEMPLARY EMBODIMENTS

It should be noted that the technical terms as used herein are merely used for describing particular embodiments, and are not intended to limit the scope of the present disclosure. Further, the technical terms in the specification should be construed as a meaning generally understood by those skilled in the art unless the terms are defined as another meaning and should not be construed as an excessively inclusive meaning or an excessively exclusive meaning. When a technical term used in the specification is an incorrect technical term which does not accurately express the idea of the present disclosure, the technical term should be replaced with the correct technical term which can be understood by those skilled in the art. Further, the general terms used in the present disclosure should be interpreted in the context according to the dictionary definition and should not be construed as possessing an excessively limited meaning.

In addition, a singular expression used in the specification includes a plural expression as long as they are clearly distinguished in the context. In the present disclosure, the term “comprise” or “include” should not be construed as necessarily including all of various elements or various steps disclosed herein, and it should be understood that some of the elements or steps may not be included, or additional elements or steps may be further included.

In addition, although terms including ordinal numbers such as first, second, and the like may be used to describe various elements, the elements should not be restricted by the terms. The terms are used merely for the purpose to distinguish an element from the other elements. For example, a first element may be termed a second element, and similarly, a second element may be termed a first element without departing from the scope of the present disclosure.

Hereinafter, embodiments of the present disclosure will be described in detail with reference to the accompanying drawings, equal or similar elements are assigned an equal reference numeral, and an overlapping description thereof will be omitted.

Further, in the following description of the technology of the present disclosure, a detailed description of known technologies incorporated herein will be omitted when it may make the subject matter of the present disclosure rather unclear. Further, it should be noted that the accompanying drawings are intended only for the easy understanding of the technical idea of the present disclosure, and the technical idea should not be construed as being limited by the accompanying drawings.

Hereinafter, a first embodiment of the present disclosure will be described with reference to the accompanying drawings.

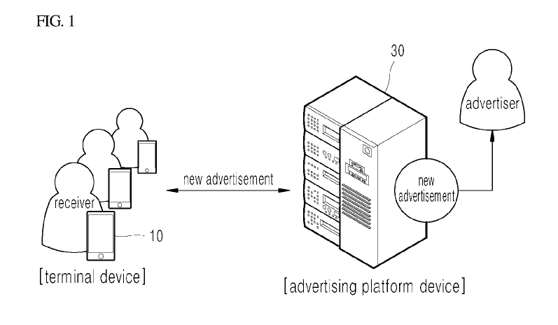

FIG. 1 illustrates an advertisement providing system according to a first embodiment of the present disclosure.

As illustrated in FIG. 1, the advertisement providing system according to the first embodiment of the present disclosure has a configuration that includes a terminal device 10 for receiving an advertisement and an advertising platform device 30 for providing an advertisement to the terminal device 10.

Further, the advertisement providing system according to the first embodiment of the present disclosure may have a configuration that further includes a service device (not shown) for providing a service page (for example, a webpage) related to an advertisement as well as the above described configuration.

The terminal device 10 refers to a mobile device that receives an advertisement through an advertisement medium and performs a series of operations such as accessing a service page related to an advertisement.

For example, the terminal device 10 may correspond to, for example, a smart phone, a tablet PC, and a PDA, but is not limited thereto and may include all devices which can receive an advertisement through an advertisement medium and execute a browser to access a service page (for example, a webpage).

The advertisement medium through which the terminal device 10 can receive an advertisement may correspond to, for example, an application executed by the terminal device 10 itself or a service page, which the terminal device 10 may access after calling a browser.

The advertisement medium includes a Software Development Kit (SDK) related to the advertisement reception in a development process and, as a result, the terminal device 10 may perform a series of operations for making a request for, receiving, and displaying the advertisement through the SDK included in the advertisement medium.

Further, the advertisement medium may support not only the above described series of functions for making the request for, receiving, and displaying the advertisement, but also a function for collecting advertisement history information.

When the advertisement within, for example, the application or the service page is received, displayed, and selected (clicked), the terminal device 10 may collect the reception, display, and selection as advertisement history information and transfer the advertisement history information to the advertising platform device 20.

Further, the terminal device 10 according to the first embodiment of the present disclosure receives the advertisement through a pull scheme for making a request for the advertisement to the advertising platform device 20 based on terminal identification information issued to the terminal device 10 and receiving the advertisement.

However, the present disclosure is not limited to the advertisement reception scheme, but the advertisement can be received through a push scheme for receiving the advertisement provided by the advertising platform device 20 without any separate request for the advertisement to the advertising platform device 20.

The advertising platform device 20 refers to an advertisement server that provides an advertisement registered by the advertiser to the terminal device 10.

When the advertiser registers a new advertisement, the advertising platform device 20 may expect an advertisement effect through a method of securing a new receiver group to receive the new advertisement and providing the new advertisement to users within the secured new receiver group.

When the new receiver group is secured, the advertising platform device 20 may allow the advertiser to select a segment (for example, a general category—sports, an intermediate category—sports wear, and a specific category—shoes) related to the type of the new advertisement and select users pre-classified ass the selected segment as the new receiver group when the new advertisement is registered.

For reference, the users who were pre-classified as the selected segment may be classified by collecting various pieces of behavior information such as purchase history, access history, and interest registration and analyzing the collected information.

The new advertisement may be provided to the users within the new receiver group in an order of requests for the advertisement since priorities of the users to receive the advertisement have not been configured.

In connection with this, when advertisement budget is sufficient, the number of times the new advertisement can be provided increases, and thus it may be expected to provide the new advertisement to all users within the new receiver group.

However, in contrast, when the advertisement budget is insufficient, the new advertisement may not be provided to all users within the new receiver group and, in this case, the new advertisement can be provided only to some of the users within the new receiver group and thus an enough advertisement effect cannot be expected.

As a result, in order expect a the maximum advertisement effect even though the new advertisement can be provided only to some of the users within the new receiver group, it is required to first provide the new advertisement to users who are highly likely to select (click) the new advertisement compared to other users within the new receiver group.

Accordingly, an embodiment of the present disclosure provides a method of setting priorities related to the reception of the new advertisement of the user within the new receiver group to receive the new advertisement and, hereinafter, the advertising platform device 20 for implementing the method will be described in detail.

Meanwhile, prior to the detailed description of the advertising platform device 20, a configuration of the terminal device 10 is described to help in understanding the description.

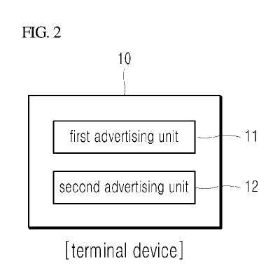

FIG. 2 illustrates the configuration of the terminal device 10 according to the first embodiment of the present disclosure.

As illustrated in FIG. 2, the terminal device 10 according to the first embodiment of the present disclosure may have a configuration that includes a first advertising unit 11 and a second advertising unit 12.

The first advertising unit 11 refers to an element for performing a series of operations related to an advertisement according to execution of an application which is an advertisement medium and may correspond to a Software Development Kit (SDK) embedded in the application.

Further, the second advertising unit 12 refers to an element for performing a series of operations related to an advertisement according to access to a service page (for example, a webpage) and may correspond to a browser as another advertisement medium.

When accessing the service page, the browser may read a source code of the SDK inserted into the service page and perform a series of operations related to the advertisement.

As described above, the browser that serves as the second advertising unit 12 may be an OS-based browser provided by an Operating System (OS) of the terminal device 10 or an application-based browser provided by an application itself executed by the terminal device 10.

For reference, the application which may provide the browser by itself may be generally named a hybrid application (for example, mobile only shopping mall application).

The entirety or at least some of the configuration of the terminal device 10 including the first advertising unit 11 and the second advertising unit 12 may be implemented in the form of a software module or a hardware module executed by a processor or may be implemented in the form of a combination of the software module and the hardware module.

As a result, the terminal device 10 according to the first embodiment of the present disclosure may receive the advertisement from the advertising platform device 20 through the above elements and display the received advertisement. Hereinafter, each element within the terminal device 10 to receive and display the advertisement will be described in detail.

The first advertising unit 11 performs a function of receiving an advertisement.

More specifically, the first advertising unit 11 makes a request for the advertisement to the advertising platform device 20 according to execution of an application and, when the advertisement is received from the advertising platform device 20 according to the request for the advertisement, displays the received advertisement in an advertisement display area designated on an execution screen of the application.

For reference, the first advertising unit 11 may issue terminal identification information by itself based on device identification information of the terminal device 10 (for example, MDN or IMEI) according to the execution of the application and make a request for the advertisement to the advertising platform device 20 based on the issued terminal identification information.

Further, the first advertising unit 11 performs a function of transferring advertisement history information.

More specifically, when selection (click) of the advertisement is made after the first advertising unit 11 displays the advertisement received from the advertising platform device 20 in the advertisement display area within the application execution screen, the first advertising unit 11 transfers information indicating the selection for the advertisement has been made to the advertising platform device 20 as the advertisement history information.

The advertisement history information transferred by the first advertising unit 11 corresponds to user behavior information and may be used for determining similarity between advertisements, which is performed by the advertising platform device 20.

The second advertising unit 12 performs a function of accessing the service page.

More specifically, when selection (click) of the advertisement within the application is identified through the first advertising unit 11, the second advertising unit 12 accesses the service page provided by a service device (not shown) based on address information inserted into the advertisement within the application, so that various services related to the advertisement (for example, selling of products) can be used through the accessed service page.

Meanwhile, it has been mentioned that the second advertising unit 12 is the element for performing a series of operations related to the advertisement according to the access to the service page (for example, the webpage) as the advertisement medium which is different from the first advertising unit 11.

The second advertising unit 12 may make a request for the advertisement to the advertising platform device 20 according to the access to the service page (for example, the webpage) separately from the first advertising unit 11 and, when the advertisement is received from the advertising platform device 20 according to the request for the advertisement, display the received advertisement in the advertisement display area on the service page.

Further, like the first advertising unit 11, when selection (click) of the advertisement is made after the second advertising unit 12 displays the advertisement received from the advertising platform device 20 in the advertisement display area within the service page, the second advertising unit 12 may transfer information indicating that the selection of the advertisement has been made to the advertising platform device 20 as the advertisement history information.

Further, when selection (click) of the advertisement within the service page is identified, the second advertising unit 12 accesses the service page provided by a service device (not shown) based on address information inserted into the advertisement like the first advertising unit 11, so that various services related to the advertisement (for example, selling of products) can be used through the accessed service page.

The description of the terminal device 10 according to the first embodiment of the present disclosure is stopped here, and a description of the advertising platform device 20 continues.

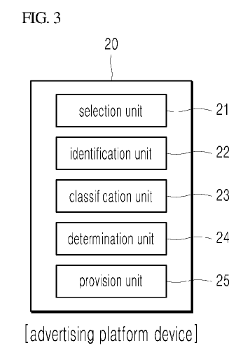

FIG. 3 illustrates a configuration of the advertising platform device 20 according to the first embodiment of the present disclosure.

As illustrated in FIG. 3, the advertising platform device 20 according to the first embodiment of the present disclosure may have a configuration that includes a selection unit 21 for selecting a new receiver group to receives a new advertisement, an identification unit 22 for identifying the existing receiver group which has been already selected for the existing advertisement having a high similarity with the new advertisement, a classification unit 23 for classifying users who overlap between the new receiver group and the existing receiver group as an overlapping receiver group, a determination unit 24 for determining priorities of users within the overlapping receiver group based on preference of the users within the overlapping receiver group for the existing advertisement, and a provision unit 25 for providing the new advertisement to the users within the overlapping receiver group according to the determined priorities.

The entirety or at least some of the configuration of the advertising platform device 20 including the selection unit 21, the identification unit 22, the classification unit 23, the determination unit 24, and the provision unit 25 may be implemented in the form of a software module or a hardware module executed by a processor or may be implemented in the form of a combination of the software module and the hardware module.

As a result, the advertising platform device 20 according to the first embodiment of the present disclosure may determine priorities related to the reception of the new advertisement of the users within the new receiver group through the above configuration and provide the new advertisement according to the determined priorities. Hereinafter, each element within the advertising platform device 20 to implement the determination and the provision will be described in more detail.

The selection unit 21 performs a function of selecting a new receiver group.

More specifically, when the advertiser registers a new advertisement, the selection unit 21 selects the new receiver group, which is a receiver group to receive the new advertisement.

At this time, when the new advertisement is registered, the selection unit 21 may allow the advertiser to select a segment (for example, a general category—sports, an intermediate category—sports wear, and a specific category—shoes) related to the type of the new advertisement and select users who were pre-classified as the selected segment as the new receiver group.

For reference, the users who were pre-classified as the selected segment may be classified by collecting various pieces of behavior information such as purchase history, access history, and interest registration and analyzing the collected information.

For example, [Table 1] below shows users classified according to segments including “Segf1” and “Segs0” that can be selected in a process of registering the new advertisement.

TABLE 1

| Segment | User ID |
|---|---|
| Segf1 | 123,1223,223,9 |
| Segs0 | 223,1283,373,2108,9877 |

When the two segments “Segf1” and “Segs0” are all selected in the process of registering the new advertisement, it may be noted that all users who are classified according to each segment can be selected as the new receiver group to receive the new advertisement.

The identification unit 22 performs a function of identifying the new receiver group and the existing receiver group.

More specifically, the identification unit 22 identifies the new receiver group selected in the process of registering the new advertisement and the existing receiver group which were pre-selected to receive the existing advertisement of which a similarity with the new advertisement is higher than equal to a threshold value.

The determination of the similarity between the new advertisement and the existing advertisement may be performed through various logics to determine a matching degree between the advertisements by comparing, for example, characteristics, kinds, and types of the advertisements such as “Item Based Recommendation”.

For example, [Table 2] below shows an example of a result of the determination of the similarity between advertisements.

TABLE 2

| Advertisement_ID | 11 | 20 | 33 | 40 | 45 | 50 | 53 |
|---|---|---|---|---|---|---|---|
| 11 | 0.5 | | | | | | |
| 20 | 0.3 | 0.5 | | | | | |
| 33 | | 0.4 | 0.5 | | | | |
| 40 | | 0.1 | | 0.5 | | | |
| 45 | | 0.12 | | | 0.5 | | |
| 50 | | 0.18 | | | | 0.5 | |
| 53 | | | | | | | 0.5 |

When the new advertisement corresponds to “20” and a similarity threshold value is “0.4”, it may be noted that an advertisement “33” and an advertisement “45” are the existing advertisements having a high similarity with the new advertisement.

The classification unit 23 performs a function of classifying the overlapping receiver group.

More specifically, when the new receiver group and the existing receiver group are identified, the classification unit 23 classifies users overlapping between the identified new receiver group and existing receiver group as the overlapping receiver group.

As a result, users who belong to both the new receiver group and the existing receiver group may be classified as the overlapping receiver group.

For reference, unlike the new receiver group, the existing receiver group may identify preference of the users within the group for the existing advertisement. The preference for the existing advertisement may be digitized through advertisement history information received from the terminal device 10, for example, by determining whether the existing advertisement is selected (clicked), whether the service page is accessed, and whether a product is purchased.

For example, [Table 3] below shows users classified as the overlapping receiver group and preference of the corresponding users for the existing advertisements in connection with the examples described with reference to [Table 1] and [Table 2].

TABLE 3

| User ID | Advertisement ID | Preference |
|---|---|---|
| 123 | 33 | 7.8 |
| 223 | 45 | 2.9 |
| 223 | 33 | 4.5 |

The determination unit 24 performs a function of determining the priorities.

More specifically, when the overlapping receiver group is classified, the determination unit 24 determines priorities of the users belonging to the overlapping receiver group with respect to the reception of the new advertisement.

At this time, the determination unit 24 determines the priorities based on the preference of the users within the overlapping receiver group for the existing advertisements. It may be determined that a user having a higher preference for the existing advertisement has a higher priority.

The higher preference for the existing advertisement may refer to a higher preference for the new advertisement having a high similarity with the existing advertisement in reverse, and, when the new advertisement is provided to the corresponding user, an advertisement effect may also be expected to increase along with the higher preference for the new advertisement.

Meanwhile, even the user belonging to the overlapping receiver group does not have the preference for the existing advertisement. The last priority may be uniformly assigned to users having no preference for the existing advertisement.

For example, [Table 4] shows that the priorities related to the reception of the new advertisement in the new receiver group are determined according to the determination of the priorities of the users within the overlapping receiver group in connection with the examples described with reference to [Table 1] and [Table 3] above.

TABLE 4

| Segment | User ID |
|---|---|
| Segf1 | 123(7.8),223(4.5),1223,223 |
| Segs0 | 223(4.5),1283,373,2108,9877 |

In a case of the priorities within the new receiver group, it may be noted that a first priority is assigned to user “123” having a large preference for the existing advertisement, a second priority is assigned to user “223”, and a third priority is assigned to all of the remaining users having no preference.

For reference, users having the same priority may receive the new advertisement in an order of a request for the advertisement.

Meanwhile, referring to [Table 3] above, it may be noted that user “223” of the second priority has the preference for both the existing advertisement “45” and “33”.

In this case, the priorities of user “223” may be determined based on preference “4.5” having a larger size between the preferences for the existing advertisements “45” and “33”.

The provision unit 240 performs a function of providing the new advertisement.

More specifically, when the priorities of the users belonging to the overlapping receiver group have been completely determined, the provision unit 240 provides the new advertisement according to the determined priorities.

At this time, when the number of times the new advertisement can be provided is equal to or smaller than the number of users within the overlapping receiver group due to the lack of advertisement budget, the provision unit 240 provides the new advertisement to at least some of the users within the overlapping receiver group according to the determined priorities.

In contrast, when the number of times the new advertisement can be provided is larger than the number of users within the overlapping receiver group due to enough advertisement budget, the provision unit 240 first provides the new advertisement to the users within the overlapping receiver group according to the determined priorities and also provides the new advertisement in number equal to the remaining number of times the advertisement can be provided in the order of the request for the advertisement to at least some of the remaining users within the new receiver group who are not classified as the overlapping receiver group.

It has been mentioned that each element within the advertising platform device 20 may be implemented in the form of the software module or hardware module executed by the processor or implemented in the form of the combination of the software module and the hardware module.

As described above, the software module and the hardware module executed by the processor, and the combination of the software module and the hardware module may be implemented by a hardware system (for example, a computer system).

Hereinafter, a hardware system 100 for implementing the advertising platform device 20 according to the first embodiment of the present disclosure will be described.

For reference, the following description is only an example for implementing each element within the advertising platform device 20 in the hardware system 100 and each element and an operation thereof may be different those in an actual system.

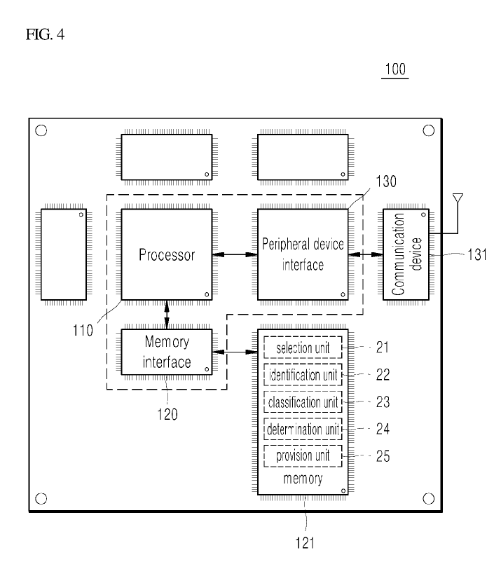

FIG. 4 illustrates a structure of the hardware system for implementing the advertising platform device 20 according to the first embodiment of the present disclosure.

As illustrated in FIG. 4, the hardware system 100 for implementing the advertising platform device 20 according to the first embodiment of the present disclosure may have a configuration that includes a processor 110, a memory interface 120, and a peripheral device interface 130.

Each element within the hardware system 100 may be an individual component or may be integrated into an integrated circuit, and such elements may be combined with a bus system (not shown).

The bus system corresponds to one or more individual physical buses, communication lines/interfaces, and/or multi-drop connected by proper bridges, adaptors, and/or controllers, or abstraction indicating or point-to-point connections.

The processor 110 serves to execute various software modules stored in a memory 121 by communicating with the memory 121 through a memory interface 120 to perform various functions in the hardware system.

The selection unit 21, the identification unit 22, the classification unit 23, the determination unit 24, and the provision unit 240 which are the elements within the advertising platform device 20 described with reference to FIG. 3 may be stored in the memory 121 in the form of a software module implemented by instructions, and an operating system may be additionally stored in the memory 121.

The operating system (for example, an embedded operating system such as I-OS, Android, Darwin, RTXC, LINUX, UNIX, OS X, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory 121 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral device interface 130 serves to allow communication between the processor 110 and peripheral devices.

The peripheral devices provide different functions to the computer system, and may include, for example, a communication device 131 in an embodiment of the present disclosure.

The communication device 131 serves to provide a communication function with another device. To this end, the communication device 131 includes, for example, an antenna system, an RF transceiver, one or more amplifiers, a tuner, one or more oscillators, a digital signal processor, a CODEC chipset, and a memory, but is not limited thereto, and may include the known circuit for performing the function.

A communication protocol supported by the communication device 131 may correspond to a protocol for, for example, Long Term Evolution (LTE), Time division Multiple Access (TDMA), Code Division Multiple Access (CDMA), Global System for Mobile communications (GSM), Enhanced Data GSM Environment (EDGE), Wideband Code Division Multiple Access (W-CDMA), Wi-Fi (IEEE 802.11a, IEEE 802.11b, IEEE 802.11g, and/or IEEE 802.11n), Bluetooth, Wi-MAX, Voice over Internet Protocol (VoIP), email, instant messaging, and Short Message Service (SMS) but is not limited thereto, and may include all protocols that provide a communication environment with another device.

As a result, when executed by the processor 110, each element within the advertising platform device 20 stored in the memory 121 in the form the software module may determine priorities of the users within the new receiver group through communication with the communication device 131 and an input/output device 132 by media of the memory interface 110 and the peripheral device interface 130 and provide the new advertisement according to the determined priorities.

Hereinafter, each element within the hardware system 100 for implementing the advertising platform device 20 will be described in detail with reference to FIG. 4.

For convenience of the description, it is assumed that each element within the advertising platform device 20 stored in the memory 121 in the form of the software module has been executed by the processor 110.

The selection unit 21 performs a function of selecting the new receiver group.

More specifically, when the new advertisement is registered by the advertiser, the selection unit 21 selects the new receiver group which is a receiver group to receive the new advertisement and transfers a result of the selection to the identification unit 22.

At this time, when the new advertisement is registered, the selection unit 21 may allow the advertiser to select a segment (for example, a general category—sports, an intermediate category—sports wear, and a specific category—shoes) related to the type of the new advertisement and select users who have been already classified as the selected segment as the new receiver group.

The identification unit 22 performs a function of identifying the new receiver group and the existing receiver group.

More specifically, the identification unit 22 identifies the new receiver group selected in a process of registering the new advertisement from the result of the selection received from the selection unit 21 and the existing receiver group corresponding to a receiver group which has been pre-selected to receive the existing advertisement of which a similar with the new advertisement is determined to be higher than or equal to a threshold value, and transfers a result of the identification to the classification unit 23.

The classification unit 23 performs a function of classifying the overlapping receiver group.

More specifically, when the result of the identification for the new receiver group and the existing receiver group is received from the identification unit 22, the classification unit 23 classifies overlapping users between the new receiver group and the existing receiver group as the overlapping receiver group and transfers a result of the classification to the determination unit 24.

The determination unit 24 performs a function of determining the priorities.

More specifically, when the result of the classification for the overlapping receiver group is received from the classification unit 23, the determination unit 24 determines priorities of the users belonging to the overlapping receiver group with respect to the reception of the new advertisement and transfers a result of the determination to the provision unit 25.

At this time, the determination unit 24 determines the priorities based on the preference of the users within the overlapping receiver group for the existing advertisements. It may be determined that a user having a larger preference for the existing advertisement has a higher priority.

Meanwhile, even the user belonging to the overlapping receiver group does not have the preference for the existing advertisement. The last priority may be uniformly assigned to users having no preference for the existing advertisement.

The provision unit 240 performs a function of providing the new advertisement.

More specifically, when a request for the advertisement is received from the users belonging to the new receiver group through the communication device 131 after the result of the determination for the priorities of the users belonging to the overlapping receiver group is received from the determination unit 230, the provision unit 240 provides the new advertisement according to the determined priorities.

At this time, when the number of times the new advertisement can be provided is equal to or smaller than the number of users within the overlapping receiver group due to the lack of advertisement budget, the provision unit 240 provides the new advertisement to at least some of the users within the overlapping receiver group according to the determined priorities.

In contrast, when the number of times the new advertisement can be provided is larger than the number of users within the overlapping receiver group due to enough advertisement budget, the provision unit 240 first provides the new advertisement to the users within the overlapping receiver group according to the determined priorities and also provide the new advertisement to at least some of the remaining users within the new receiver group who are not classified as the overlapping receiver group in the order of the request for the advertisement the remaining number of times the advertisement can be provided.

As described above, it may be noted that the advertising platform device 20 according to the first embodiment of the present disclosure determines the priorities of the users within the new receiver group selected to receive the new advertisement based on priorities for the existing advertisements having a higher similarity with the new advertisement and first provides the new advertisement to users who are expected to have high interest in the new advertisement according to the determined priorities, thereby achieving an effect of improving an advertisement effect.

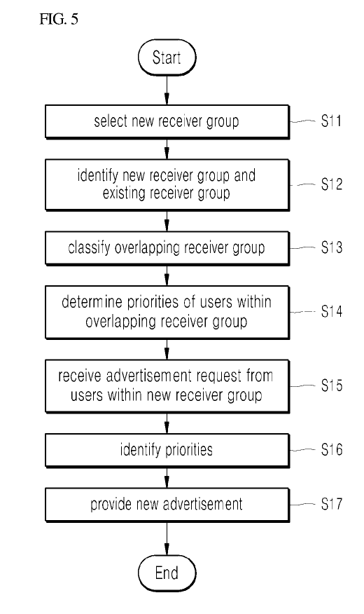

Hereinafter, a flow of operations performed in the advertising platform device 20 according to the first embodiment of the present disclosure will be described with reference to FIG. 5.

First, when the advertiser registers the new advertisement, the selection unit 21 selects the new receiver group, which is a receiver group to receive the new advertisement in S11.

At this time, when the new advertisement is registered, the selection unit 21 may allow the advertiser to select a segment (for example, a general category—sports, an intermediate category—sports wear, and a specific category—shoes) related to the type of the new advertisement and select users who have been already classified as the selected segment as the new receiver group.

For reference, the users who were pre-classified as the selected segment may be classified by collecting various pieces of behavior information such as purchase history, access history, and interest registration and analyzing the collected information.

Subsequently, the identification unit 22 identifies the new receiver group selected in a process of registering the new advertisement and the existing receiver group corresponding to a receiver group which has been pre-selected to receive the existing advertisement of which a similarity with the new advertisement is determined to be higher than or equal to a threshold value in S12.

The determination of the similarity between the new advertisement and the existing advertisement may be performed through various logics to determine a matching degree between the advertisements by comparing, for example, characteristics, kinds, and types of the advertisements such as “Item Based Recommendation”.

Then, when the new receiver group and the existing receiver are identified, the classification unit 23 classifies overlapping users between the identified new receiver group and existing receiver group as the overlapping receiver group in S13.

As a result, users who belong to both the new receiver group and the existing receiver group may be classified as the overlapping receiver group.

For reference, unlike the new receiver group, the existing receiver group may identify preference of the users within the group for the existing advertisement. The preference for the existing advertisement may be digitized through advertisement history information received from the terminal device 10, for example, by determining whether the existing advertisement is selected (clicked), whether the service page is accessed, and whether a product is purchased.

Further, when the overlapping receiver group is classified, the determination unit 24 determines priorities of the users belonging to the overlapping receiver group with respect to the reception of the new advertisement in S14.

At this time, the determination unit 24 determines the priorities based on the preference of the users within the overlapping receiver group for the existing advertisements. It may be determined that a user having a larger preference for the existing advertisement has a higher priority.

The higher preference for the existing advertisement may refer to a higher preference for the new advertisement having a high similarity with the existing advertisement in reverse, and, when the new advertisement is provided to the corresponding user, an advertisement effect may also be expected to increase along with the higher preference for the new advertisement.

Meanwhile, even the user belonging to the overlapping receiver group does not have the preference for the existing advertisement. The last priority may be uniformly assigned to users having no preference for the existing advertisement.

Thereafter, when the determination of the priorities of the users belonging to the overlapping receiver group is completed, the provision unit 240 provides the new advertisement according to the determined priorities in S15 to S17.

At this time, when the number of times the new advertisement can be provided is equal to or smaller than the number of users within the overlapping receiver group due to the lack of advertisement budget, the provision unit 240 provides the new advertisement to at least some of the users within the overlapping receiver group according to the determined priorities.

In contrast, when the number of times the new advertisement can be provided is larger than the number of users within the overlapping receiver group due to enough advertisement budget, the provision unit 240 first provides the new advertisement to the users within the overlapping receiver group according to the determined priorities and also provide the new advertisement to at least some of the remaining users within the new receiver group who are not classified as the overlapping receiver group in the order of the request for the advertisement the remaining number of times the advertisement can be provided.

As described above, according to the flow of the operations in the advertising platform device 20 according to the first embodiment of the present disclosure, it may be noted that the advertising platform device 20 determines the priorities of the users within the new receiver group selected to receive the new advertisement based on priorities for the existing advertisements having a higher similarity with the new advertisement and first provides the new advertisement to users who are expected to have high interest in the new advertisement according to the determined priorities, thereby achieving an effect of improving an advertisement effect.

Hereinafter, a second embodiment of the present disclosure will be described with reference to the accompanying drawings.

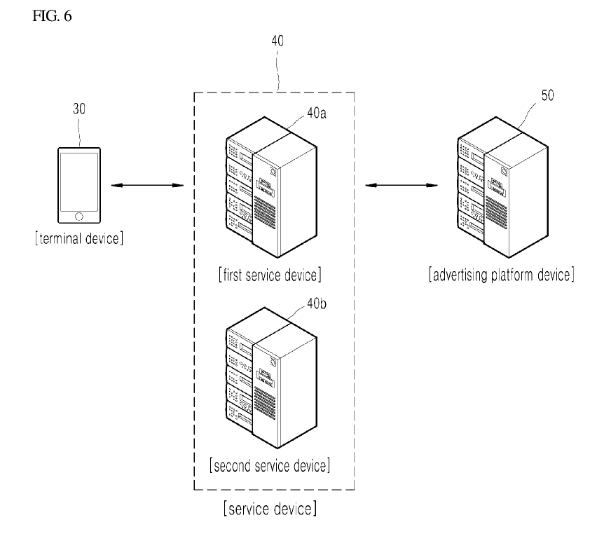

FIG. 6 illustrates an advertisement providing system according to a second embodiment of the present disclosure.

As illustrated in FIG. 6, the advertisement providing system according to the second embodiment of the present disclosure may have a configuration that includes a terminal device 30 for receiving an advertisement, a service device 40 for providing each service page (for example, a webpage), and an advertising platform device 50 for providing an advertisement to the terminal device 30.

The terminal device 30 refers to a mobile device that receives an advertisement through an advertisement medium and performs a series of operations such as access to a service page related to the advertisement.

For example, the terminal device 30 may correspond to, for example, a smart phone, a tablet PC, and a PDA but is not limited thereto, and may include all devices which can receive an advertisement through an advertisement medium and execute a browser to access a service page.

The advertisement medium through which the terminal device 30 can receive an advertisement may correspond to, for example, an application executed by the terminal device 30 itself or a service page, which the terminal device 30 may access after calling a browser.

The advertisement medium includes a Software Development Kit (SDK) related to the advertisement reception in a development process and, as a result, the terminal device 30 may perform a series of operations for making a request for, receiving, and displaying the advertisement through the SDK included in the advertisement medium.

Further, the advertisement medium may support not only a series of processes described above such as making the request for, receiving, and displaying the advertisement, but also a function of collecting information performed by the advertising platform device 50.

The terminal device 30 may collect and transfer various pieces of information such as, for example, advertisement selection information within an application or a service page, an application execution log, a service page access log, and service use history information.

Further, the terminal device 30 may receive the advertisement through a pull scheme for making a request for and receiving the advertisement from the advertising platform device 50 based on terminal identification information issued to the terminal device 30 but is not limited thereto, and the terminal device 30 may receive the advertisement through a push scheme for receiving the advertisement provided by the advertising platform device 50 without a separate request for the advertisement.

The service device 40 refers to a web server (for example, an open market server or a shopping mall server) that provides each service page (for example, webpage), which the terminal device 30 can access through a browser.

When the terminal device 30 accesses the service page, the service device 40 allows the accessed terminal device 30 to use various services (for example, product purchase, sale, and guide) through the service page.

At this time, when the terminal device 30 initially accesses the service page, the service device 40 issues predetermined terminal identification information, and the terminal identification information may be recorded as access log information (for example, a cookie file) within the browser of the terminal device 30.

When the terminal device 30 accesses the service page again after the terminal identification information is issued, the service device 40 may identify the terminal identification information from the access log information within the browser and recognize that the terminal device 30 accesses its own service page again.

Further, when the use of the service by the terminal device 30 performed in the service page is finished, the service device 40 may transfer log information of the terminal device 30 related to the service page to the advertising platform device 50 along with the terminal identification information.

The advertising platform device 50 refers to an advertisement server that provides an advertisement registered by the advertiser to the terminal device 30 according to a request for the advertisement from the terminal device 30.

When the request for the advertisement is received from the terminal device 30, the advertising platform device 50 selects and provides a proper advertisement to the user having the terminal device 30.

Meanwhile, according to an embodiment of the present disclosure, the advertising platform device 50 follows an advertisement targeting scheme for selecting the advertisement suitable for the user and providing the selected advertisement as described above.

In connection with this, a segment-based advertisement-targeting scheme was used in the conventional arts.

For reference, the segment-based advertisement targeting scheme refers to a scheme for providing a target advertisement by determining a segment that defines user characteristics based on accumulated data such as data (for example, Impression, Click, PV, and UV) which can be acquired from the advertisement medium and customer service use information (for example, a purchase pattern and an amount of phone calls) which can be shared in a corresponding business area and then identifying a segment to which the user having made the request for the advertisement belongs.

However, the segment-based targeting scheme has a limitation in that the segment-based targeting scheme can be performed only through a process of identifying the user based on an assumption of consent to the use of user's personal information, for example, by inquiring about login information on the service page and device identification information (for example, MDN and IMEI) possessed by the user.

As a result, the conventional advertisement-targeting scheme may provide the target advertisement only to users who do agree with the use of personal information and may randomly provide an advertisement to users who do not agree with the use of personal information, so that it may be expected that an advertisement effect cannot be ensured.

Accordingly, an embodiment of the present disclosure proposes a method of providing the target advertisement to users who do not agree with the use of personal information and, hereinafter, a configuration of the advertising platform device 50 for implementing the method will be described in detail.

Meanwhile, prior to the detailed description of the advertising platform device 50, a configuration of the terminal device 30 is described to help in understanding the description.

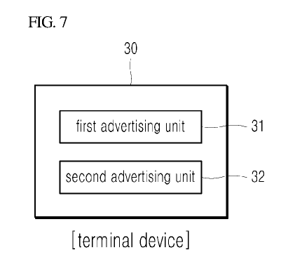

FIG. 7 illustrates a configuration of the terminal device 30 according to the second embodiment of the present disclosure.

As illustrated in FIG. 7, the terminal device 30 according to the second embodiment of the present disclosure may have a configuration that includes a first advertising unit 31 and a second advertising unit 32.

The first advertising unit 31 refers to an element for performing a series of operations related to an advertisement according to execution of an application which is an advertisement medium and may correspond to a Software Development Kit (SDK) embedded in the application.

Further, the second advertising unit 32 refers to an element for performing a series of operations related to an advertisement according to access to a service page (for example, a webpage) and may correspond to a browser as another advertisement medium.

When accessing the service page, the browser may read a source code of the SDK inserted into the service page and perform a series of operations related to the advertisement

As described above, the browser that serves as the second advertising unit 32 may be an OS-based browser provided by an Operating System (OS) of the terminal device 30 or an application-based browser provided by an application itself executed by the terminal device 30.

For reference, the application that may provide the browser by itself may be generally named a hybrid application (for example, mobile only shopping mall application).

The entirety or at least some of the configuration of the terminal device 30 including the first advertising unit 31 and the second advertising unit 32 may be implemented in the form of a software module or a hardware module executed by a processor or may be implemented in the form of a combination of the software module and the hardware module.

As a result, the terminal device 30 according to the second embodiment of the present disclosure may receive the advertisement from the advertising platform device 50 through the above elements and display the received advertisement. Hereinafter, each element within the terminal device 30 to receive and display the advertisement will be described in detail.

The first advertising unit 31 performs a function of receiving the advertisement.

More specifically, the first advertising unit 31 makes a request for the advertisement to the advertising platform device 50 according to execution of an application and, when the advertisement is received from the advertising platform device 50 according to the request for the advertisement, displays the received advertisement in an advertisement display area designated on an execution screen of the application.

For reference, the first advertising unit 31 may issue terminal identification information by itself based on device identification information of the terminal device 30 (for example, MDN or IMEI) according to the execution of the application and make a request for the advertisement to the advertising platform device 50 based on the issued terminal identification information.

Further, the first advertising unit 31 performs a function of transferring advertisement history information.

More specifically, when selection (click) of the advertisement is made after the first advertising unit 31 displays the advertisement received from the advertising platform device 20 in the advertisement display area within the application execution screen, the first advertising unit 11 transfers information indicating the selection of the advertisement has been made to the advertising platform device 50 as the advertisement history information.

The advertisement history information transferred by the first advertising unit 100 corresponds to user behavior information and may be used for determining similarity between advertisements, which is performed by the advertising platform device 50.

The second advertising unit 32 performs a function of accessing the service page.

More specifically, when selection (click) of the advertisement within the application is identified through the first advertising unit 31, the second advertising unit 32 accesses the service page provided by a service device 40 based on address information inserted into the advertisement within the application, so that various services related to the advertisement (for example, sales of products) can be used through the accessed service page.

Meanwhile, it has been mentioned that the second advertising unit 32 is the element for performing a series of operations related to the advertisement according to the access to the service page (for example, the webpage) as the advertisement medium which is different from the first advertising unit 31.

The second advertising unit 32 may make a request for the advertisement to the advertising platform device 50 according to the access to the service page (for example, the webpage) separately from the first advertising unit 31 and, when the advertisement is received from the advertising platform device 50 according to the request for the advertisement, display the received advertisement in the advertisement display area on the service page.

Further, like the first advertising unit 31, when selection (click) of the advertisement is made after the second advertising unit 32 displays the advertisement from the advertising platform device 20 in the advertisement display area within the service page, the second advertising unit 12 may transfer information indicating that the selection of the advertisement has been made to the advertising platform device 50 as the advertisement history information.

Further, when selection (click) of the advertisement within the service page is identified, the second advertising unit 32 accesses the service page provided by a service device (not shown) based on address information inserted into the advertisement like the first advertising unit 31, so that various services related to the advertisement (for example, selling of products) can be used through the accessed service page.

The description of the terminal device 30 according to the second embodiment of the present disclosure is stopped here, and a description of the advertising platform device 50 continues.

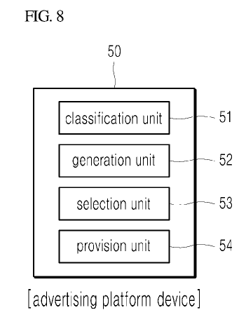

FIG. 8 illustrates a configuration of the advertising platform device 50 according to the second embodiment of the present disclosure.

As illustrated in FIG. 8, the advertising platform device 50 according to the second embodiment of the present disclosure may have a configuration that includes a classification unit 51 for classifying an accessor group related to the service device 40, a generation unit 52 for generating an item list related to the accessor group, a selection unit 53 for selecting at least some of the advertisements related to the generated item list, and a provision unit 54 for providing the selected advertisements.

The entirety or at least some of the elements of the advertising platform device 50 including the classification unit 51, the generation unit 52, the selection unit 53, and the provision unit 54 may be implemented in the form of a software module or a hardware module executed by the processor or implemented the form of a combination of the software module and the hardware module.

As a result, the advertising platform device 50 according to the second embodiment of the present disclosure may provide a targeted advertisement to users who do not agree with the use of personal information through a scheme of classifying an accessor group having a particular log information pattern identified in the service device 40 and providing an advertisement related to an item which the classified accessor group prefers. Hereinafter, each element within the advertising platform device 50 for implementing the provision of the targeted advertisement will be described in detail.

Meanwhile, it is assumed that the service device 40 according to the second embodiment of the present disclosure is divided into a first service device 40a and a second service device 40b related to the first service device 40a, and a detailed description thereof will be made below.

The classification unit 51 performs a function of classifying the accessor group.

More specifically, the classification unit 51 classifies a first accessor group having a particular log information pattern identified in the first service device 40a and a second accessor group having the particular log information pattern identically identified in the second service device 40b having a correlation with the first service device 40a which is higher than or equal to a threshold value.

The particular log information pattern refers to a behavior pattern of an accessor identified from log information received from the first service device 40a and the second service device 40b and includes, for example, a particular behavior pattern of an access such as “purchasing a sports item five times or more in one month”.

For reference, according to an embodiment of the present disclosure, each of the accessors classified as the first accessor group and the second accessor group may be considered as a user who does not agree with the use of personal information but is not limited thereto, and users who agree with the use of personal information may be classified as the first accessor group and the second accessor group.

Meanwhile, the correlation between the first service device 40a and the second service device 40b may be determined based on, for example, classification items of the layer structure including a general category item of a higher layer and a specific category item of a lower layer. As the first service device 40a and the second service device 40b are classified as the same particular classification item among the classification items of the layer structure and the particular classification item corresponds to a classification item of a lower layer, it may be determined that the correlation is higher.

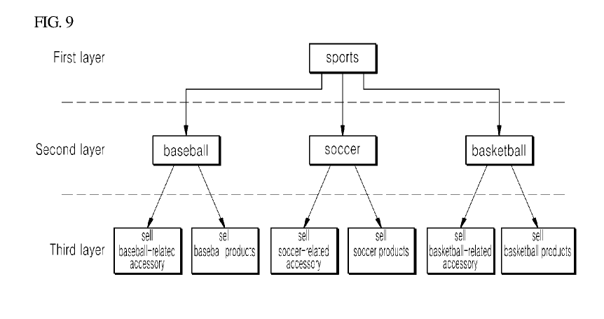

FIG. 9 illustrates an example of the classification items of the layer structure.

When the first service device 40a is classified as “baseball” and the second service device 40b is classified as “soccer”, it may be determined that the first service device 40a and the second service device 40b have the correlation therebetween since both “baseball” and “soccer” are associated with the classification item “sports” in a first layer even though classification items thereof in a second layer are different.

When the first service device 40a and the second service device 40b are identically classified as “soccer” in the second layer, it may be determined that the first service device 40a and the second service device 40b have a higher correlation compared to the above case where the first service device 40a and the second service device 40b are classified as different layers. When the first service device 40a and the second service device 40b are identically classified as “sell baseball products” in a third layer, it may be determined that the correlation is much higher.

The generation unit 52 performs a function of generating the item list.

More specifically, when the first accessor group and the second accessor group are classified, the generation unit 52 generates a first item list having a preference higher than or equal to a threshold value within the first accessor group among items (for example, products on sale) related to the first service device 40a and a second item list having a preference higher than or equal to a threshold value within the second accessor group among items (for example, products on sale) related to the second service device 40b.

At this time, a priority that reflects the size of the preference within the first accessor group and the preference within the second accessor group may be assigned to each of the items included in the first item list and the second item list.

The preference within the first accessor group and the preference within the second accessor group correspond to indexes indicating how much the accessor prefers the item serviced through the service page in each of the first service device 40a and the second service device 40b, and may be determined from log information received from each of the first service device 40a and the second service device 40b, for example, by identifying a behavior pattern of the accessor such as purchasing, searching for, and inquiring for the item.

The selection unit 53 performs a function of selecting the advertisement to be provided to the accessor group.

More specifically, when the first item list and the second item list are generated, the selection unit 53 selects at least some of the advertisements related to each of the first item list and the second item list as the advertisements to be provided to the first accessor group and the second accessor group.

At this time, the selection of the advertisements to be provided to each of the first accessor group and the second accessor group may be performed using, for example, the correlation between the first service device 40a and the second service device 40b and whether the first item list and the second item match each other.

First, when the advertisements are selected based on the correlation between the first service device 40a and the second service device 40b, as the correlation between the first service device 40a and the second service device 40b is higher, the selection unit 53 selects, from each of the first item list and the second item list, advertisements related to items with a lower priority as advertisements to be provided to each of the first accessor group and the second accessor group.

Although it will be described below in more detail, according to an embodiment of the present disclosure, the advertisement related to the first item list is provided to the second accessor group and, inversely, the advertisement related to the second item list is provided to the first accessor group.

The higher correlation between the first service device 40a and the second service device 40b may mean that the accessor belonging to the second accessor group is highly likely to prefer the item preferred by the first accessor group and, inversely, the accessor belonging to the first accessor group is highly likely to prefer the item preferred by the second accessor group.

Further, when the correlation between the first service device 40a and the second service device 40b is higher, the item having a low priority within the first item list may be highly likely to be preferred by the second accessor group and, inversely, the item having a lower priority within the second item list may be highly likely to be preferred by the second accessor group.

Accordingly, based on the above matter, as the correlation between the first service device 40a and the second service device 40b is higher, the selection unit 53 may select, from each of the first item list and the second item list, advertisements related to items from a high priority to a lower priority as advertisements to be provided to each of the first accessor group and the second accessor group.

When the advertisements are selected based on whether the first item list and the second item list match each other, the selection unit 53 selects advertisements related to the remaining items except for overlapping items between the first item list and the second item list as the advertisements to be provided to each of the first accessor group and the second accessor group.

The overlapping items may be considered as items which both the first accessor group and the second accessor group have been interested in and already purchased, so that the further interest of the first accessor group and the second accessor group in the overlapping items cannot be guaranteed.

Accordingly, based on the above matter, the selection unit 53 may select only the advertisements related to the remaining items except for the overlapping items between the first item list and the second item list as the advertisements to be provided to each of the first accessor group and the second accessor group.

The provision unit 54 performs a function of providing the selected advertisements.

More specifically, the provision unit 54 provides selected advertisements related to the first item list to the second accessor group and selected advertisements related to the second item list to the first accessor group.

As a result, the provision unit 54 alternately provides advertisements related to interesting items within the first accessor group and the second accessor group having the same behavior pattern in the first service device 40a and the second service device 40b to the first accessor group and the second accessor group, thereby expecting an advertisement effect such as the targeting advertisement scheme that targets event users who do not agree with the use of personal information.

It has been mentioned that each element within the advertising platform device 50 may be implemented in the form of the software module or hardware module executed by the processor or implemented in the form of the combination of the software module or hardware module.

As described above, the software module and the hardware module executed by the processor, and the combination of the software module and the hardware module may be implemented by a hardware system (for example, a computer system).

Hereinafter, a hardware system 200 for implementing the advertising platform device 50 according to the second embodiment of the present disclosure will be described.

For reference, the following description is only an example for implementing each element within the advertising platform device 50 in the hardware system 200 and each element and an operation thereof may be different those in an actual system.

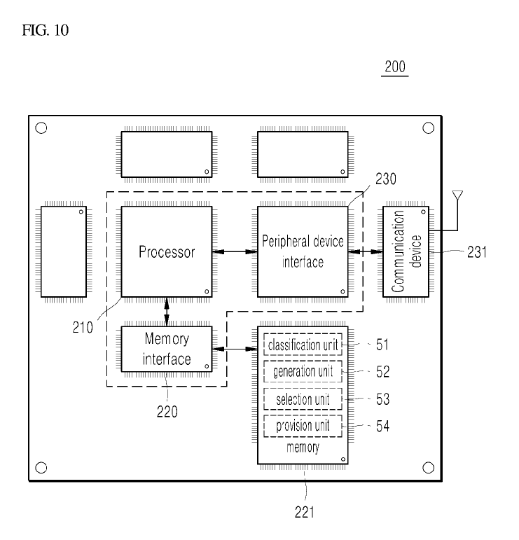

FIG. 10 illustrates a structure of the hardware system for implementing the advertising platform device 50 according to the second embodiment of the present disclosure.

As illustrated in FIG. 10, the hardware system 200 for implementing the advertising platform device 50 according to the second embodiment of the present disclosure may have a configuration that includes a processor 210, a memory interface 220, and a peripheral device interface 230.

Each element within the hardware system 200 may be an individual component or may be integrated into an integrated circuit, and such elements may be combined with a bus system (not shown).

The bus system corresponds to one or more individual physical buses, communication lines/interfaces, and/or multi-drop connected by proper bridges, adaptors, and/or controllers, or abstraction indicating or point-to-point connections.

The processor 210 serves to execute various software modules stored in a memory 221 by communicating with the memory 221 through a memory interface 220 to perform various functions in the hardware system.

The classification unit 51, the generation unit 52, the selection unit 53, and the provision unit 54 which are the elements within the advertising platform device 50 described with reference to FIG. 8 may be stored in the memory 221 in the form of a software module implemented by instructions, and an operating system may be additionally stored in the memory 221.

The operating system (for example, an embedded operating system such as I-OS, Android, Darwin, RTXC, LINUX, UNIX, OS X, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory 221 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral device interface 230 serves to allow communication between the processor 210 and peripheral devices.

The peripheral devices provide different functions to the computer system, and may include, for example, a communication device 231 in an embodiment of the present disclosure.

The communication device 231 serves to provide a communication function with another device. To this end, the communication device 131 includes, for example, an antenna system, an RF transceiver, on or more amplifiers, a tuner, one or more oscillators, a digital signal processor, a CODEC chipset, and a memory, but is not limited thereto, and may include a known circuit for performing the function.

A communication protocol supported by the communication device 231 may correspond to a protocol for, for example, Long Term Evolution (LTE), Time division Multiple Access (TDMA), Code Division Multiple Access (CDMA), Global System for Mobile communications (GSM), Enhanced Data GSM Environment (EDGE), Wideband Code Division Multiple Access (W-CDMA), Wi-Fi (IEEE 802.11a, IEEE 802.11b, IEEE 802.11g, and/or IEEE 802.11n), Bluetooth, Wi-MAX, Voice over Internet Protocol (VoIP), email, instant messaging, and Short Message Service (SMS) but is not limited thereto, and may include all protocols that provide a communication environment with another device.

As a result, when executed by the processor 210, each element within the advertising platform device 50 stored in the memory 221 in the form of the software module may provide the targeted advertisement even to users who do not agree with the use of personal information by communicating with a communication device 231 and an input/output device 232 by a medium of the memory interface 220 and the peripheral device interface 230.

Hereinafter, each element within the hardware system 200 for implementing the advertising platform device 50 will be described in detail.

For convenience of the description, it is assumed that each element within the advertising platform device 50 stored in the memory 121 in the form of the software module has been executed by the processor 210.

The classification unit 51 performs a function of classifying the accessor group.

More specifically, the classification unit 51 classifies the first accessor group having a particular log information pattern identified in the first service device 40a and the second accessor group having the particular log information pattern identically identified in the second service device 40b having a correlation with the first service device 40a which is higher than or equal to a threshold value, and transfers a result of the classification to the generation unit 52.

The correlation between the first service device 40a and the second service device 40b may be determined based on, for example, classification items of the layer structure including a general category item of a higher layer and a specific category item of a lower layer. As the first service device 40a and the second service device 40b are classified as the same particular classification item among the classification items of the layer structure and the particular classification item corresponds to a classification item of a lower layer, it may be determined that the correlation is higher.

The generation unit 52 performs a function of generating the item list.

More specifically, when the result of the classification for the first accessor group and the second accessor group is received, the generation unit 52 generates the first item list having a preference within the first accessor group which is higher than or equal to a threshold value among the items (for example, products on sale) related to the first service device 40a and the second item list having a preference within the second accessor group which is higher than or equal to a threshold value among the items (for example, products on sale) related to the second service device 40b, and transfers a result of the generation to the selection unit 53.

At this time, a priority that reflects the size of the preference within the first accessor group and the preference within the second accessor group may be assigned to each of the items included in the first item list and the second item list.

The preference within the first accessor group and the preference within the second accessor group correspond to indexes indicating how much the accessor prefers the item serviced through the service page in each of the first service device 40a and the second service device 40b, and may be determined from log information received from each of the first service device 40a and the second service device 40b, for example, by identifying a behavior pattern of the accessor such as purchasing, searching for, and inquiring for the item.

The selection unit 53 performs a function of selecting the advertisement to be provided to the accessor group.

More specifically, when the result of the generation for the first item list and the second item list is received, the selection unit 53 selects at least some of the advertisements related to each of the first item list and the second item list as advertisements to be provided to the first accessor group and the second accessor group and transfers a result of the selection to the provision unit 54.

At this time, the selection unit 53 may select the advertisements to be provided to each of the first accessor group and the second accessor group based on a correlation between the first service device 40a and the second service device 40b and whether the first item list and the second item list match each other.

When the correlation between the first service device 40a and the second service device 40b is used, as the correlation between the first service device 40a and the second service device 40b is higher, the selection unit 53 selects, from each of the first item list and the second item list, advertisements related to items from a high priority to a lower priority as advertisements to be provided to each of the first accessor group and the second accessor group.

Further, in a case of using the determination of whether the first item list and the second item list match each other, the selection unit 53 may select advertisements related to the remaining items except for overlapping items between the first item list and the second item list as the advertisements to be provided to each of the first accessor group and the second accessor group.

The provision unit 54 performs a function of providing the selected advertisements.

More specifically, when a result of the selection of the advertisements is received, the provision unit 54 provides selected advertisements related to the first item list to the second accessor group and selected advertisements related to the second item list to the first accessor group through the communication device 231.

As described above, the advertising platform device 50 according to the second embodiment of the present disclosure may classify the first accessor group and the second accessor group of which the log information pattern is identically identified in the first service device 40a and the second service device 40b having a correlation therebetween higher than or equal to a threshold value and alternately provide the advertisements related to the interesting items within the first accessor group and the second accessor group to the first accessor group and the second accessor group, thereby expecting an advertisement effect such as the targeting advertisement scheme that targets even users who do not agree with the use of personal information.

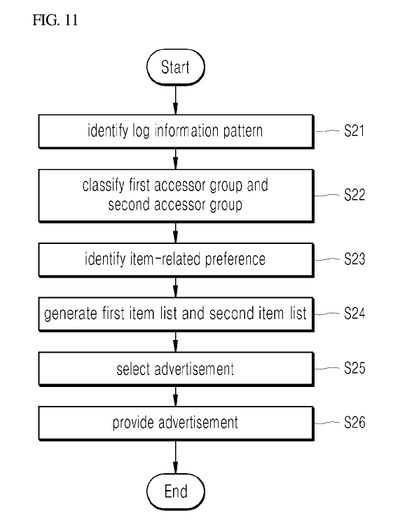

Hereinafter, a flow of the operations of the advertising platform device 50 according to the second embodiment of the present disclosure will be described with reference to FIG. 11.

First, in steps “S21” and “S22”, the classification unit 51 classifies the first accessor group having a particular log information pattern identified in the first service device 40a and the second accessor group having the particular log information pattern identically identified in the second service device 40b having a correlation with the first service device 40a which is higher than or equal to a threshold value.

The particular log information pattern refers to a behavior pattern of an accessor identified from log information received from the first service device 40a and the second service device 40b and includes, for example, a particular behavior pattern of an access such as “purchasing a sport item five times or more in one month”.

Meanwhile, the correlation between the first service device 40a and the second service device 40b may be determined based on, for example, classification items of the layer structure including a general category item of a higher layer and a specific category item of a lower layer. As the first service device 40a and the second service device 40b are classified as the same particular classification item among the classification items of the layer structure and the particular classification item corresponds to a classification item of a lower layer, it may be determined that the correlation is higher.

Subsequently, when the first accessor group and the second accessor group are classified, the generation unit 52 generates a first item list having a preference higher than or equal to a threshold value within the first accessor group among items (for example, products on sale) related to the first service device 40a and a second item list having a preference higher than or equal to a threshold value within the second accessor group among items (for example, products on sale) related to the second service device 40b in steps “S23” and “S24”.

At this time, a priority that reflects the size of the preference within the first accessor group and the preference within the second accessor group may be assigned to each of the items included in the first item list and the second item list.

The preference within the first accessor group and the preference within the second accessor group correspond to indexes indicating how much the accessor prefers the item serviced through the service page in each of the first service device 40a and the second service device 40b, and may be determined from log information received from each of the first service device 40a and the second service device 40b, for example, by identifying a behavior pattern of the accessor such as purchasing, searching for, and inquiring for the item.

Then, when the first item list and the second item list are generated, the selection unit 53 selects at least some of the advertisements related to each of the first item list and the second item list as the advertisements to be provided to the first accessor group and the second accessor group in step “S25”.

At this time, the selection of the advertisements to be provided to each of the first accessor group and the second accessor group may be performed using, for example, the correlation between the first service device 40a and the second service device 40b and whether the first item list and the second item match each other.

First, when the advertisements are selected using the correlation between the first service device 40a and the second service device 40b, as the correlation between the first service device 40a and the second service device 40b is higher, the selection unit 53 selects, from each of the first item list and the second item list, advertisements related to items from a high priority to a lower priority as advertisements to be provided to each of the first accessor group and the second accessor group.

The higher correlation between the first service device 40a and the second service device 40b may mean that the accessor belonging to the second accessor group is highly likely to prefer the item preferred in the first accessor group and, inversely, the accessor belonging to the first accessor group is highly likely to prefer the item preferred in the second accessor group.

Further, when the correlation between the first service device 40a and the second service device 40b is higher, the item having a low priority within the first item list may be highly likely to be preferred by the second accessor group and, inversely, the item having a lower priority within the second item list may be highly likely to be preferred by the second accessor group.

Accordingly, based on the above matter, as the correlation between the first service device 40a and the second service device 40b is higher, the selection unit 53 selects, from each of the first item list and the second item list, advertisements related to items from a high priority to a lower priority as advertisements to be provided to each of the first accessor group and the second accessor group.

When the advertisements are selected based on whether the first item list and the second item list match each other, the selection unit 53 selects advertisements related to the remaining items except for overlapping items between the first item list and the second item list as the advertisements to be provided to each of the first accessor group and the second accessor group.

The overlapping items may be considered as items which both the first accessor group and the second accessor group have been interested in and already purchased, so that the interest of the first accessor group and the second accessor group in the overlapping items cannot be guaranteed.

Accordingly, based on the above matter, the selection unit 53 may select only the advertisements related to the remaining items except for the overlapping items between the first item list and the second item list as the advertisements to be provided to each of the first accessor group and the second accessor group.

Thereafter, in step “S26”, the provision unit 54 provides selected advertisements related to the first item list to the second accessor group and selected advertisements related to the second item list to the first accessor group.

At this time, the provision unit 54 alternately provides advertisements related to interesting items within the first accessor group and the second accessor group having the same behavior pattern in the first service device 40a and the second service device 40b to the first accessor group and the second accessor group, thereby expecting an advertisement effect such as the targeting advertisement scheme that targets event users who do not agree with the use of personal information.

As described above, the advertising platform device 50 according to the second embodiment of the present disclosure may classify the first accessor group and the second accessor group having the same log information pattern identified in the first service device 40a and the second service device 40b having a correlation therebetween higher than or equal to a threshold value and alternately provide the advertisements related to the interesting items within the first accessor group and the second accessor group to the first accessor group and the second accessor group, thereby expecting an advertisement effect such as the targeting advertisement scheme that targets even users who do not agree with the use of personal information.

Hereinafter, a third embodiment of the present disclosure will be described with reference to the accompanying drawings.

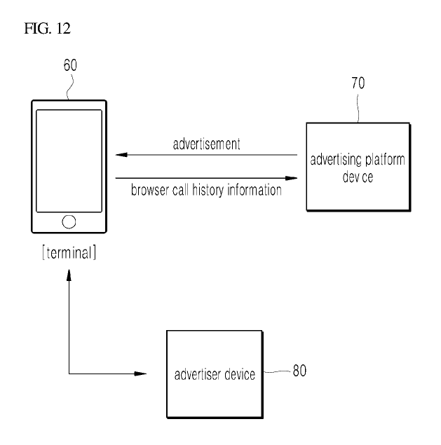

FIG. 12 illustrates an advertisement providing system according to the third embodiment of the present disclosure.

As illustrated in FIG. 12, the advertisement providing system according to the third embodiment of the present disclosure may have a configuration that includes a terminal 60 for receiving an advertisement and an advertising platform device 70 for providing an advertisement to the terminal 60.

Further, the advertisement providing system according to the third embodiment of the present disclosure may have a configuration that further includes an advertiser device 80 for providing an advertiser page (webpage) that the terminal 60 having selected (clicked) the advertisement can access as well as the aforementioned configuration.

The terminal 60 refers to a mobile device that receives an advertisement through an advertisement medium and performs a series of operations such as access to the service page through advertisement selection.

For example, the terminal 60 may correspond to, for example, a smart phone, a tablet PC, and a PDA but is not limited thereto, and may include all devices which can receive an advertisement through an advertisement medium and execute a browser to access an advertiser page (for example, a webpage).

The advertisement medium through which the terminal 60 can receive an advertisement may correspond to, for example, an application executed by the terminal 60 itself or a service page which the terminal 60 can access after calling a browser.

The advertisement medium includes a Software Development Kit (SDK) related to the advertisement reception in a development process and, as a result, the terminal 60 may perform a series of operations for making a request for, receiving, and displaying the advertisement through the SDK included in the advertisement medium.

For reference, the advertisement medium may support not only a series of functions described above such as making the request for, receiving, and displaying the advertisement, but also collection of advertisement history information performed by the advertising platform device 70.

The terminal 60 may receive, display, and select (click) the advertisement within, for example, the application or the service page and, when accessing the advertiser page through selection of the advertisement, transfer the access to the advertising platform device 70 as advertisement history information.

Further, the terminal 60 according to the third embodiment of the present disclosure may receive the advertisement through a pull scheme for making a request for and receiving the advertisement from the advertising platform device 70 based on device identification information of the terminal 60 but is not limited thereto, and the terminal 60 may receive the advertisement through a push scheme for receiving the advertisement provided by the advertising platform device 70 without making a separate request for the advertisement to the advertising platform device 70.

The advertising platform device 70 refers to an advertisement server that provides an advertisement to the terminal 60, and may collect and manage advertisement history information received from the terminal 60 as statistical information as well as providing the advertisement.

When the advertisement is selected in the terminal 60, the advertiser device 80 refers to a web server (for example, an open market or a shopping mall) that provides an advertiser page which the terminal 60 can access.

The advertiser device 80 may provide various services (for example, product purchase, sale, and guide) related to the advertiser to the terminal 60 that has accessed the service page through the selection of the advertisement.

Meanwhile, it has been mentioned that the advertising platform device 70 according to the third embodiment of the present disclosure collects and manages the advertisement history information received from the terminal 60 as the statistical information as well as providing the advertisement.

The collected statistical information corresponds to important information used for measuring an advertisement effect and settling up expense, and accuracy of the collected statistical information should be first corrected.

However, the advertisement history information collected as the statistical information is highly likely to be fabricated through various types of abuse. When the advertisement history information is fabricated, the generation of errors in measuring the advertisement effect and settling up the advertisement expense may be expected.

Accordingly, an embodiment of the present disclosure provides a method of effectively detecting the generation of the abuse of the advertisement medium and, hereinafter, a configuration of the advertising platform device 70 for implementing the method will be described in detail.

Meanwhile, prior to the detailed description of the advertising platform device 70, a configuration of the terminal 60 is described to help in understanding the present disclosure.

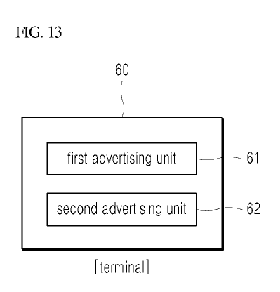

FIG. 13 illustrates the configuration of the terminal 60 according to the third embodiment of the present disclosure.

As illustrated in FIG. 13, the terminal 60 according to the third embodiment of the present disclosure may have a configuration that includes a first advertising unit 61 and a second advertising unit 62.

The first advertising unit 61 refers to an element for performing a series of operations related to an advertisement according to execution of an application which is an advertisement medium and may correspond to a Software Development Kit (SDK) embedded in the application.

Further, the second advertising unit 62 refers to an element for performing a series of operations related to an advertisement according to access to a service page (for example, a webpage) and may correspond to a browser as another advertisement medium.

When accessing the service page (webpage), the browser may read a source code of the SDK inserted into the service page and perform a series of operations related to the advertisement

As described above, the browser that serves as the second advertising unit 62 may be an OS-based browser provided by an Operating System (OS) of the terminal 60 or an application-based browser provided by an application itself executed by the terminal 60.

For reference, the application which may provide the browser by itself may be generally named a hybrid application (for example, mobile only shopping mall application).

All or at least some of the configuration of the terminal 60 including the first advertising unit 61 and second advertising unit 62 may be implemented in the form of a software module or a hardware module executed by the processor or implemented in the form of a combination of the software module and the hardware module.

As a result, the terminal 60 according to the third embodiment of the present disclosure receives the advertisement from the advertising platform device 70 through the above configuration and displays the received advertisement. When the advertisement is selected, the terminal 60 accesses an advertiser page provided by an advertiser device 80. Hereinafter, each element within the terminal 60 therefor will be described in detail.

The first advertising unit 61 performs a function of receiving the advertisement.

More specifically, the first advertising unit 61 makes a request for the advertisement to the advertising platform device 70 according to execution of an application and, when the advertisement is received from the advertising platform device 70 according to the request for the advertisement, displays the received advertisement in an advertisement display area designated on an execution scree of the application.

At this time, the first advertising unit 61 may make a request for the advertisement to the advertising platform device 70 based on device identification information (for example, MDN or IMEI) of the terminal 60 according to execution of an application.

Further, the first advertising unit 61 performs a function of making a request for access to the advertiser device 80.

More specifically, when selection (click) for the advertisement is identified after the advertisement received from the advertising platform device 70 is displayed in an advertisement display area within an application execution screen, the first advertising unit 61 makes a request for access to the advertiser device 80 to the second advertising unit 62.

The selected advertisement may include address information of the advertiser device 80. When the selection (click) for the advertisement is identified, the first advertising unit 61 may make the request for the access to the advertiser device 80 by transferring the address information included in the advertisement to the second advertising unit 62.

Further, when the access to the advertiser device 80 is performed through the selection (click) for the advertisement after the advertisement received from the advertising platform device 70 is displayed in the advertisement display area within the application execution screen, the first advertising unit 61 transfers the access to the advertising platform device 70 as advertisement history information.

The second advertising unit 62 performs a function of accessing the service page.

More specifically, when the selection (click) for the advertisement within the application is identified through the first advertising unit 61, the second advertising unit 62 may access the advertiser device 80 based on the address information received from the first advertising unit 61 so that various services (for example, purchase of products) provided by the advertiser device 80 can be used.

Meanwhile, it has been mentioned that the second advertising unit 62 is the element for performing a series of operations related to the advertisement according to the access to the service page (for example, the webpage) as the advertisement medium which is different from the first advertising unit 61.

The second advertising unit 62 may make a request for the advertisement to the advertising platform device 70 according to access to the service page (for example, webpage) separately from the first accessing unit 61 and, when the advertisement is received from the advertising platform device 70 according to the request for advertisement, display the received advertisement in an advertisement display area on the service page.

Further, when the selection (click) for the advertisement is identified after the advertisement received from the advertising platform device 70 is displayed in the advertisement display area within the service page, like the first advertising unit 62, the second advertising unit 62 may access the advertiser device 80 based on the address information inserted into the advertisement, so that various services (for example, selling of products) provided by the advertiser device 80 can be used.

In addition, when the access to the advertiser device 80 through the selection (click) for the advertisement is performed after the advertisement received from the advertising platform device 70 is displayed in the advertisement display area within the service page, like the first advertising unit 61, the second advertising unit 62 may transfer information on the access to the advertising platform device 70 as the advertisement history information.

Meanwhile, the advertisement history information which the first advertising unit 61 and the second advertising unit 62 transfer to the advertising platform device 70 may include browser call history information that contains identification information (type) of the browser called by each of the first advertising unit 61 and the second advertising unit 62 to access the advertiser device 80 and advertisement medium identification information corresponding to identification information of each of the first advertising unit 61 and the second advertising unit 62.

The description of the terminal 60 according to the third embodiment of the present disclosure is finished herein and a description of the advertising platform device 70 continues.

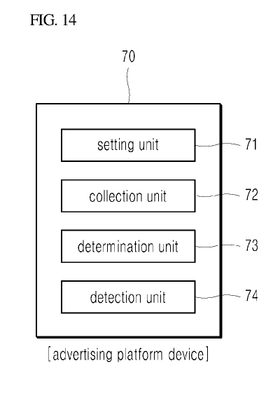

FIG. 14 illustrates a schematic configuration of the advertising platform device 70 according to the third embodiment of the present disclosure.

As illustrated in FIG. 14, the advertising platform device 70 according to the third embodiment of the present disclosure may have a configuration that includes a setting unit 71 for setting browser policy information in connection with the advertisement medium, a collection unit 72 for collecting browser call history information, a determination unit 73 for determining a similarity between a browser call pattern (hereinafter, referred to as a “first browser call pattern”) defined in the browser policy information and a browser call pattern (hereinafter, referred to as a “second browser call pattern”) identified from the browser call history information, and a detection unit 74 for detecting abuse based on a result of the determination of the similarity.

All or at least some of the configuration of the advertising platform device 70 including the setting unit 71, the collection unit 72, the determination unit 73, and the detection unit 74 may be implemented in the form of a software module or a hardware module executed by the processor or implemented in the form of a combination of the software module and the hardware module.

As a result, the advertising platform device 70 according to the third embodiment of the present disclosure may effectively detect the generation of the abuse of the advertisement medium through the above elements and, hereinafter, each element within the advertising platform device 70 for implementing the effective detection will be described in detail.

The setting unit 71 performs a function of setting browser policy information.

More specifically, in connection with the advertisement medium, the setting unit 71 sets browser policy information that defines a browser to be called by the terminal 60 having selected the advertisement within the advertisement medium.

The browser policy information corresponds to information to define a type of the browser which should be called by the terminal 60 having selected the advertisement within the advertisement medium and is differently set according to each advertisement medium.

The browser policy information includes information on a plurality of browsers which should be called by the terminal 60 having selected the advertisement within the advertisement medium, and a priority (for example, 1. Chrome, 2. Samsung browser, and 3. Basic browser) for the call by the terminal 60 may be assigned to each of the plurality of browsers.

When selection for the advertisement is performed after the browser policy information is set in connection with the advertisement medium, the terminal 60 first calls a particular browser having the highest priority among the plurality of browsers according to the set browser policy information and accesses the advertiser device 80. When there is no corresponding browser, the terminal 60 calls a browser having the next highest priority and accesses the advertiser device 80.

Accordingly, the first browser call pattern defined in the browser policy information may be understood as a call pattern that reflects the priority of each of the plurality of browsers which should be called by the terminal having selected the advertisement within the advertisement medium.

The setting of the browser policy information corresponds to a change in the logic of the SDK within the advertisement medium and may be repeated according to a preset period (for example, every 24 hours). The priority for the plurality of browsers within the browser policy information in each period may be assigned differently from a previous period.

The period on which the browser policy information is set is relevant to a detection time for which a subject to perform the abuse can detect the change in the logic of the SDK, and a time interval between periods should be set to be shorter than the detection time.

For reference, the setting of the browser policy information is performed through a link protocol between the advertising platform device 70 and the SDK within the advertisement medium, and the setting unit 71 may set browser policy information within the advertisement medium through a policy manager function related to the link protocol.

The collection unit 72 performs a function of collecting browser call history information.

More specifically, the collection unit 72 collects browser call history information related to the browser which is actually called by the terminal 60 having selected the advertisement within the advertisement medium from several terminals 60.

The second browser call pattern corresponding to a pattern of the browser actually called by the terminal 60 may be identified from the collected browser call history information, and may be understood as a call pattern that reflects a priority according to the number of times each of the plurality of browsers is actually called by the terminal 60 having selected the advertisement within the advertisement medium.

The determination unit 73 performs a function of determining a similarity between the first browser call pattern and the second browser call pattern.

More specifically, the determination unit 73 determines whether the similarity between the first browser call pattern and the second browser call pattern is smaller than a threshold value by identifying how much a priority for each of a plurality of browsers within the first browser call pattern matches a priority for each of a plurality of browsers within the second browser call pattern.

At this time, the determination unit 73 may determine that the similarity between the first browser call pattern and the second browser call pattern is smaller than the threshold value when the number of browsers among the plurality of browsers included in the first browser call pattern of which the priority is changed in the second browser call pattern is larger than or equal to the threshold value or when there is a particular browser among the plurality of browsers included in the first browser call pattern of which the priority is changed in the second browser call pattern and a range of the change in the priority of the corresponding browser is larger than or equal to the threshold value.

A condition for determining that the similarity between the first browser call pattern and the second browser call pattern is smaller than the threshold value may be variously defined and is not limited to a particular condition.

The detection unit 74 performs a function of determining whether abuse is generated in the advertisement medium.

More specifically, when it is determined that the similarity between the first browser call pattern and the second browser call pattern is smaller than the threshold value, the detection unit 74 detects the generation of the abuse in the advertisement medium.

The similarity between the first browser call pattern and the second browser call pattern which is smaller than the threshold value means that a degree of matching between the first browser call pattern and the second browser call pattern is low, and may be understood as information in which the collected browser call history information is fabricated by the abuse generated in the advertisement medium.

When the abuse is not generated in the advertisement medium, it should be determined that the similarity between the first browser call pattern and the second browser call pattern is larger than or equal to the threshold value and the degree of the matching between the first browser call pattern and the second browser call pattern is high.

Meanwhile, in order to account for a case in which it may be determined that the similarity between the first browser call pattern and the second browser call pattern is temporarily smaller than a threshold value, only when the number of times it determined that the similarity between the first browser call pattern and the second browser call pattern is smaller than the threshold value is higher than or equal to a threshold value, the detection unit 74 may detect the generation of abuse in the advertisement medium.

Meanwhile, it has been mentioned that each element within the advertising platform device 70 may be implemented in the form of the software module or hardware module executed by the processor or implemented in the form of the combination of the software module or hardware module.

As described above, the software module and the hardware module executed by the processor, and the combination of the software module and the hardware module may be implemented by a hardware system (for example, a computer system).

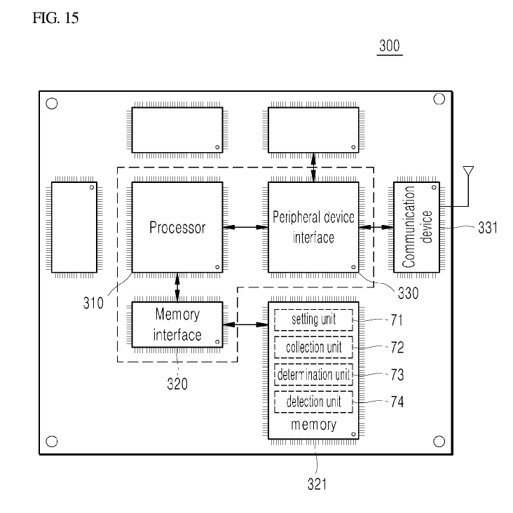

Accordingly, hereinafter, a hardware system 300 for implementing the advertising platform device 70 according to the third embodiment of the present disclosure will be described with reference to FIG. 15.

For reference, the following description is only an example for implementing each element within the advertising platform device 50 in the hardware system 300 and each element and an operation thereof may be different those in an actual system.

FIG. 15 illustrates a structure of the hardware system for implementing the advertising platform device 70 according to the third embodiment of the present disclosure.

As illustrated in FIG. 15, the hardware system 300 for implementing the advertising platform device 70 according to the third embodiment of the present disclosure may have a configuration that includes a processor 310, a memory interface 320, and a peripheral device interface 330.

Each element within the hardware system 300 may be an individual component or may be integrated into an integrated circuit, and such elements may be combined with a bus system (not shown).

The bus system corresponds to one or more individual physical buses, communication lines/interfaces, and/or multi-drop connected by proper bridges, adaptors, and/or controllers, or abstraction indicating or point-to-point connections.

The processor 310 serves to execute various software modules stored in a memory 321 by communicating with the memory 321 through a memory interface 320 to perform various functions in the hardware system.

The setting unit 71, the collection unit 72, the determination unit 73, and the detection unit 74 corresponding to elements within the advertising platform device 70 described with reference to FIG. 14 may be stored in the memory 321 in the form of the software module and an operating system may be additionally stored in the memory 321.

The operating system (for example, an embedded operating system such as I-OS, Android, Darwin, RTXC, LINUX, UNIX, OS X, WINDOWS, or VxWorks) includes various procedures for controlling and managing general system tasks (for example, memory management, storage device control, and power management), an instruction set, a software component, and/or a driver, and serves to make communication between various hardware modules and software modules easy.

For reference, the memory 321 includes a cache, a main memory, and a secondary memory but is not limited thereto, and may include a memory layer structure. The memory layer structure may be implemented through a predetermined combination of, for example, a RAM (for example, SRAM, DRAM, or DDRAM), a ROM, a FLASH, a magnetic and/or optical storage device (for example, a disk drive, a magnetic tape, a Compact Disk (CD), and a Digital Video Disc (DVD)).

The peripheral device interface 330 serves to allow communication between the processor 310 and peripheral devices.

The peripheral devices provide different functions to the computer system, and may include, for example, a communication device 331 in an embodiment of the present disclosure.

The communication device 331 serves to provide a communication function with another device. To this end, the communication device 131 includes, for example, an antenna system, an RF transceiver, on or more amplifiers, a tuner, one or more oscillators, a digital signal processor, a CODEC chipset, and a memory, but is not limited thereto, and may include a known circuit for performing the function.

A communication protocol supported by the communication device 331 may correspond to a protocol for, for example, Long Term Evolution (LTE), Time division Multiple Access (TDMA), Code Division Multiple Access (CDMA), Global System for Mobile communications (GSM), Enhanced Data GSM Environment (EDGE), Wideband Code Division Multiple Access (W-CDMA), Wi-Fi (IEEE 802.11a, IEEE 802.11b, IEEE 802.11g, and/or IEEE 802.11n), Bluetooth, Wi-MAX, Voice over Internet Protocol (VoIP), email, instant messaging, and Short Message Service (SMS) but is not limited thereto, and may include all protocols that provide a communication environment with another device.

As a result, when executed by the processor 310, each element within the advertising platform device 70 stored in the memory 321 in the form of the software module may effectively detect the abuse generated in the advertisement medium by communicating with a communication device 331 and an input/output device 332 by a medium of the memory interface 320 and the peripheral device interface 330.

Hereinafter, each element within the hardware system 300 for implementing the advertising platform device 70 will be described in detail with reference to FIG. 15.

For convenience of the description, it is assumed that each element within the advertising platform device 70 stored in the memory 321 in the form of the software module has been executed by the processor 310.

The setting unit 71 performs a function of setting browser policy information.

More specifically, the setting unit 71 sets browser policy information that defines a browser which should be called by the terminal 60 having selected the advertisement within the advertisement medium through the communication device 331 in connection with the advertisement medium.

At this time, the setting of the browser policy information is performed through a link protocol between the advertising platform device 70 and the SDK within the advertisement medium, and the setting unit 71 may set browser policy information within the advertisement medium through a policy manager function related to the link protocol.

The setting of the browser policy information corresponds to a change in the logic of the SDK within the advertisement medium and may be repeated according to a preset period (for example, every 24 hours). The priority for the plurality of browsers within the browser policy information in each period may be assigned differently.

When selection for the advertisement is performed after the browser policy information is set in connection with the advertisement medium, the terminal 60 first calls a particular browser having a highest priority among the plurality of browsers according to the set browser policy information and accesses the advertiser device 80. When there is no corresponding browser, the terminal 60 calls a browser having a next priority and accesses the advertiser device 80.

The collection unit 72 performs a function of collecting browser call history information.

More specifically, the collection unit 72 collects browser call history information related to the browser which is actually called by the terminal 60 having selected the advertisement within the advertisement medium from several terminals 60 through the communication device 331 and transfers the collected browser call history information to the determination unit 73.

The second browser call pattern corresponding to a pattern of the browser actually called by the terminal 60 may be identified from the collected browser call history information, and may be understood as a call pattern that reflects a priority according to the number of times each of the plurality of browsers is actually called by the terminal 60 having selected the advertisement within the advertisement medium.

The determination unit 73 performs a function of determining a similarity between the first browser call pattern and the second browser call pattern.

More specifically, when the browser call history information is received from the collection unit 72, the determination unit 73 determines whether the similarity between the first browser call pattern and the second browser call pattern is smaller than a threshold value by identifying how much a priority for each of a plurality of browsers within the first browser call pattern defined in the browser policy information matches a priority for each of a plurality of browsers within the second browser call pattern identified from the browser call history information, and transfers a result of the determination to the detection unit 74.

At this time, the determination unit 73 may determine that the similarity between the first browser call pattern and the second browser call pattern is smaller than the threshold when the number of browsers among the plurality of browsers included in the first browser call pattern of which the priority is changed in the second browser call pattern is larger than or equal to the threshold value or when there is a particular browser among the plurality of browsers included in the first browser call pattern of which the priority is changed in the second browser call pattern and a range of the change in the priority of the corresponding browser is larger than or equal to the threshold value.

A condition for determining that the similarity between the first browser call pattern and the second browser call pattern is smaller than the threshold value may be variously defined and is not limited to a particular condition.

The detection unit 74 performs a function of determining whether abuse is generated in the advertisement medium.

More specifically, when it is determined that the similarity between the first browser call pattern and the second browser call pattern is smaller than the threshold value based on the result of the determination received from the determination unit 73, the detection unit 74 detects the generation of the abuse in the advertisement medium.

The similarity between the first browser call pattern and the second browser call pattern which is smaller than the threshold means that a degree of matching between the first browser call pattern and the second browser call pattern is low, and may be understood as information in which the collected browser call history information is fabricated by the abuse generated in the advertisement medium.

When the abuse is not generated in the advertisement medium, it should be determined that the similarity between the first browser call pattern and the second browser call pattern is larger than or equal to the threshold value and the degree of the matching between the first browser call pattern and the second browser call pattern is high.

Meanwhile, in order to account for a case in which it may be determined that the similarity between the first browser call pattern and the second browser call pattern is temporarily smaller than a threshold value, only when the number of times it determined that the similarity between the first browser call pattern and the second browser call pattern is smaller than the threshold value is higher than or equal to a threshold value, the detection unit 74 may detect the generation of abuse in the advertisement medium.

As described above, according to the advertising platform device 70 according to the third embodiment of the present disclosure and the hardware system 300 for implementing the same, it is possible to effectively detect whether the abuse is generated in the advertisement medium by determining the similarity between the first browser call pattern defined in the browser policy information set in connection with the advertisement medium and the second browser call pattern made by the terminal 60 having selected the advertisement within the advertisement medium.

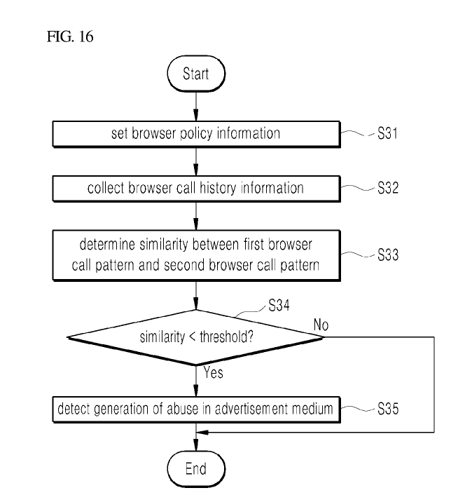

Hereinafter, a flow of the operations of the advertising platform device 70 according to the third embodiment of the present disclosure will be described with reference to FIG. 16.

First, the setting unit 71 sets browser policy information that defines a browser which should be called by the terminal 60 having selected the advertisement within the advertisement medium in connection with the advertisement medium in step “S31”.

At this time, the setting of the browser policy information is performed through a link protocol between the advertising platform device 70 and the SDK within the advertisement medium, and the setting unit 71 may set browser policy information within the advertisement medium through a policy manager function related to the link protocol.

The setting of the browser policy information corresponds to a change in the logic of the SDK within the advertisement medium and may be repeated according to a preset period (for example, every 24 hours). The priority for the plurality of browsers within the browser policy information in each period may be assigned differently.

When selection for the advertisement is performed after the browser policy information is set in connection with the advertisement medium, the terminal 60 first calls a particular browser having a highest priority among the plurality of browsers according to the set browser policy information and accesses the advertiser device 80. When there is no corresponding browser, the terminal 60 calls a browser having a next priority and accesses the advertiser device 80.

Then, the collection unit 72 collects browser call history information related to the browser which is actually called by the terminal 60 having selected the advertisement within the advertisement medium from the terminal 60 in step “S32”.

The second browser call pattern corresponding to a pattern of the browser actually called by the terminal 60 may be identified from the collected browser call history information, and may be understood as a call pattern that reflects a priority according to the number of times each of the plurality of browsers is actually called by the terminal 60 having selected the advertisement within the advertisement medium.

Subsequently, the determination unit 73 determines whether the similarity between the first browser call pattern and the second browser call pattern is smaller than a threshold value by identifying how much a priority for each of a plurality of browsers within the first browser call pattern defined within the browser policy information matches a priority for each of a plurality of browsers within the second browser call pattern identified from the browser call history information in step “S33”.

At this time, the determination unit 73 may determine that the similarity between the first browser call pattern and the second browser call pattern is smaller than the threshold when the number of browsers among the plurality of browsers included in the first browser call pattern of which the priority is changed in the second browser call pattern is larger than or equal to the threshold value or when there is a particular browser among the plurality of browsers included in the first browser call pattern of which the priority is changed in the second browser call pattern and a range of the change in the priority of the corresponding browser is larger than or equal to the threshold value.

A condition for determining that the similarity between the first browser call pattern and the second browser call pattern is smaller than the threshold value may be variously defined and is not limited to a particular condition.

Thereafter, when it is identified that the similarity between the first browser call pattern and the second browser call pattern is smaller than the threshold value, the detection unit 74 detects the generation of the abusing in the advertisement medium.

The similarity between the first browser call pattern and the second browser call pattern which is smaller than the threshold value means that a degree of matching between the first browser call pattern and the second browser call pattern is low, and may be understood as information in which the collected browser call history information is fabricated by the abuse generated in the advertisement medium.

When the abuse is not generated in the advertisement medium, it should be determined that the similarity between the first browser call pattern and the second browser call pattern is larger than or equal to the threshold value and the degree of the matching between the first browser call pattern and the second browser call pattern is high.

Meanwhile, in order to account for a case in which it may be determined that the similarity between the first browser call pattern and the second browser call pattern is temporarily smaller than a threshold value, only when the number of times it determined that the similarity between the first browser call pattern and the second browser call pattern is smaller than the threshold value is higher than or equal to a threshold value, the detection unit 74 may detect the generation of abuse in the advertisement medium.

As described above, according to the flows of the operations of the advertising platform device 70 according to the third embodiment of the present disclosure, it is possible to effectively detect whether the abuse is generated in the advertisement medium by determining the similarity between the first browser call pattern defined in the browser policy information set in connection with the advertisement medium and the second browser call pattern made by the terminal 60 having selected the advertisement within the advertisement medium.

The implementations of the functional operations and subject matter described in the present disclosure may be realized by a digital electronic circuit, by the structure described in the present disclosure and the equivalent including computer software, firmware, or hardware including, or by a combination of one or more thereof. Implementations of the subject matter described in the specification may be implemented in one or more computer program products, that is, one or more modules related to a computer program command encoded on a tangible program storage medium to control an operation of a processing system or the execution by the operation.

A computer-readable medium may be a machine-readable storage device, a machine-readable storage substrate, a memory device, a composition of materials influencing a machine-readable radio wave signal, or a combination of one or more thereof.

In the specification, the term “system” or “device”, for example, covers a programmable processor, a computer, or all kinds of mechanisms, devices, and machines for data processing, including a multiprocessor and a computer. The processing system may include, in addition to hardware, a code that creates an execution environment for a computer program when requested, such as a code that constitutes processor firmware, a protocol stack, a database management system, an operating system, or a combination of one or more thereof.

A computer program (also known as a program, software, software application, script, or code) can be written in any form of programming language, including compiled or interpreted languages, declarative or procedural languages, and it can be deployed in any form, including as a stand-alone program or module, a component, subroutine, or another unit suitable for use in a computer environment. A computer program may, but need not, correspond to a file in a file system. A program can be stored in a single file provided to the requested program, in multiple coordinated files (for example, files that store one or more modules, sub-programs, or portions of code), or in a portion of a file that holds other programs or data (for example, one or more scripts stored in a markup language document). A computer program can be deployed to be executed on one computer or on multiple computers that are located at one site or distributed across a plurality of sites and interconnected by a communication network.

A computer-readable medium suitable for storing a computer program command and data includes all types of non-volatile memories, media, and memory devices, for example, a semiconductor memory device such as an EPROM, an EEPROM, and a flash memory device, and a magnetic disk such as an external hard disk or an external disk, a magneto-optical disk, a CD-ROM, and a DVD-ROM disk. A processor and a memory may be added by a special purpose logic circuit or integrated into the logic circuit.

Implementations of the subject matter described in the specification may be implemented in a calculation system including a back-end component such as a data server, a middleware component such as an application server, a front-end component such as a client computer having a web browser or a graphic user interface which can interact with the implementations of the subject matter described in the specification by the user, or all combinations of one or more of the back-end, middleware, and front-end components. The components of the system can be mutually connected by any type of digital data communication such as a communication network or a medium.

While the specification contains many specific implementation details, these should not be construed as limitations on the scope of any disclosure or of what may be claimed, but rather as descriptions of features that may be specific to particular embodiments of particular disclosures. Certain features that are described in the specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

In addition, in the specification, the operations are illustrated in a specific sequence in the drawings, but it should not be understood that the operations are performed in the shown specific sequence or that all shown operations are performed in order to obtain a preferable result. In a specific case, a multitasking and parallel processing may be preferable. Furthermore, it should not be understood that a separation of the various system components of the above-mentioned implementation is required in all implementations. In addition, it should be understood that the described program components and systems usually may be integrated in a single software package or may be packaged in a multi-software product.

As described above, specific terms disclosed in the specification do not intend to limit the present disclosure. Therefore, while the present disclosure was described in detail with reference to the above-mentioned examples, a person skilled in the art may modify, change and transform some parts without departing a scope of the present disclosure. The scope of the present disclosure is defined by the appended claims to be described later, rather than the detailed description. Accordingly, it will be appreciated that all modifications or variations derived from the meaning and scope of the appended claims and their equivalents are included in the range of the present disclosure.

1. An advertising platform device comprising:
a processor configured to perform an operation related to a new advertisement; and
a memory configured to store at least one instruction executed through the processor,
wherein the at least one instruction comprises:
an identification instruction for identifying a new receiver group selected in connection with the new advertisement and an existing receiver group which has been pre-selected in connection with an existing advertisement having a similarity with the new advertisement larger than or equal to a threshold value;
a classification instruction for classifying overlapping users between the new receiver group and the existing receiver group as an overlapping receiver group; and
a determination instruction for determining priorities of users within the overlapping receiver group based on a preference of the users within the overlapping receiver group with respect to the existing advertisement and providing the new advertisement to each of the user within the overlapping receiver group according to the priorities.

2. The advertising platform device of claim 1, wherein, when a segment related to a type of the new advertisement is selected when the new advertisement is registered, the at least one instruction further comprises a selection instruction for selecting users classified as the selected segment as the new receiver group.

3. The advertising platform device of claim 1, wherein, when a number of times the new advertisement can be provided is equal to or smaller than a number of users within the overlapping receiver group, the at least one instruction further comprises a provision instruction for providing the new advertisement to at least some of the users within the overlapping receiver group according to the priories.

4. The advertising platform device of claim 1, wherein, when a number of times the new advertisement can be provided is larger than a number of users within the overlapping receiver group, the at least one instruction further comprises a provision instruction for first providing the new advertisement to the users within the overlapping receiver group according to the priorities and providing the new advertisement to at least some of remaining users within the new receiver group who are not classified as the overlapping receiver group a remaining number of times the new advertisement can be provided.

5. The advertising platform device of claim 1, wherein, when a number of existing advertisements is larger than or equal to 2 and a particular user within the overlapping receiver group has preferences for both the two or more existing advertisements, the determination instruction determines a priority of the particular user based on a highest preference between the preferences for the two or more existing advertisements.

6. An advertising platform device comprising:
a processor configured to perform an operation related to an advertisement; and
a memory configured to store at least one instruction executed through the processor,
wherein the at least one instruction comprises:
a classification instruction for classifying a first accessor group having a particular log information pattern is identified in a first service device and a second accessor group having the particular log information pattern identically identified in a second service device having a correlation with the first service device higher than or equal to a threshold value; and
a generation instruction for generating a first item list having a preference higher than or equal to a threshold value within the first access group among items related to the first service device and providing advertisements related to the first item list to the second accessor group.

7. The advertising platform device of claim 6, wherein the correlation between the first service device and the second service device is determined based on classification items of a layer structure including a general category item of a higher layer and a specific category item of a lower layer.

8. The advertising platform device of claim 7, wherein the correlation between the first service device and the second service device is determined to be higher as the first service device and the second service device are classified as an equal particular classification item among the classification items of the layer structure and the particular item corresponds to a classification item of a lower layer.

9. The advertising platform device of claim 6, wherein the generation instruction generates a second item list having a preference higher than or equal to a threshold value within the second access group among items related to the second service device and providing advertisements related to the second item list to the first accessor group.

10. The advertising platform device of claim 9, wherein at least one instruction further comprises a selection instruction for selecting advertisements to be provided to each of the first accessor group and the second accessor group based on at least one of the correlation between the first service device and the second service device and whether the first item list matches the second item list.

11. The advertising platform device of claim 10, wherein a priority according to degrees of a preference within the first accessor group and a preference within the second accessor group is assigned to each of the first item list and the second item list, and the selection instruction selects, from each of the first item list and the second item list, advertisements related to items with lower priority for the advertisements to be provided to each of the first accessor group and the second accessor group as the correlation between the first service device and the second service device is higher.

12. The advertising platform device of claim 10, wherein the selection instruction selects advertisements related to remaining items except for overlapping items between the first item list and the second item list as the advertisements to be provided to each of the first accessor group and the second accessor group.

13. An advertising platform device comprising:
a processor configured to perform an operation related to detecting whether abuse is generated in an advertisement medium; and
a memory configured to store at least one instruction executed through the processor,
wherein the at least one instruction comprises:
a setting instruction for setting browser policy information that defines a browser which should be called by a terminal having selected an advertisement within the advertisement medium in connection with the advertisement medium;
a collection instruction for collecting browser call history information related to a browser which is called by the terminal having selected an advertisement within the advertisement medium; and
a detection instruction for detecting the generation of the abuse in the advertisement medium when it is determined that a similarity between a first browser call pattern defined in the browser policy information and a second browser call pattern identified from the browser call history information is smaller than a threshold value.

14. The advertising platform device of claim 13, wherein a plurality of browsers which should be called by the terminal having selected an advertisement within the advertisement medium are set in the browser policy information.

15. The advertising platform device of claim 14, wherein the first browser call pattern is associated with a priority of each of the plurality of browsers which should be called by the terminal having selected an advertisement within the advertisement medium and the second browser call pattern is associated with a priority of each of the plurality of browsers based on a number of times the browser is called by the terminal having selected an advertisement within the advertisement medium.

16. The advertising platform device of claim 15, wherein the at least one instruction further comprises a determination instruction for determining a similarity between the first browser call pattern and the second browser call pattern based on whether the priority of said each of the plurality of browsers in the first browser call pattern is changed in the second browser call pattern.

17. The advertising platform device of claim 16, wherein, when a number of browsers, of which a priority is changed in the second browser call pattern, among the plurality of browsers is larger than or equal to a threshold value, the determination instruction determines that the similarity between the first browser call pattern and the second browser call pattern is smaller than the threshold value.

18. The advertising platform device of claim 16, wherein, when there is a particular browser, of which a priority is changed in the second browser call pattern, in the plurality of browsers and when the priority of the particular browser in the second browser call pattern is changed by a threshold value or more from the priority in the first browser call pattern, the determination instruction determines that the similarity between the first browser call pattern and the second browser call pattern is smaller than the threshold value.

19. The advertising platform device of claim 13, wherein the browser policy information in every preset period in connection with the advertisement medium is set differently from a previous period, and the determination instruction detects that abuse is generated in the advertisement medium when an accumulation number of times it is determined that the similarity between the first browser call pattern and the second browser call pattern is smaller than the threshold value in each period is larger than or equal to a threshold value.
